(19) United States
(12) Patent Application Publication
(10) Pub. No.: US 2024/0310985 A1
(43) Pub. Date: Sep. 19, 2024

(54) METHOD OF CHANGING LAYOUT OF OBJECTS, INFORMATION PROCESSING APPARATUS, AND COMPUTER READABLE STORAGE MEDIUM

(71) Applicant: CANON KABUSHIKI KAISHA, Tokyo (JP)

(72) Inventor: YOSHINORI HASHIMOTO, Tokyo (JP)

(21) Appl. No.: 18/598,043

(22) Filed: Mar. 7, 2024

(30) Foreign Application Priority Data
Mar. 13, 2023 (JP) 2023-038398

(51) Int. Cl. G06F 3/04845; G06F 3/0483; G06F 3/0486; G06T 11/00

(52) U.S. Cl. CPC G06F 3/04845; G06F 3/0483; G06T 11/00; G06F 3/0486; G06T 2200/24; G06T 2210/21

(57) ABSTRACT

An information processing apparatus includes a detection unit configured to detect an operation of changing a position or a size of a master object which is displayed on a screen, another detection unit configured to detect detecting at least one subordinate object, which is displayed on the screen and in a symmetric arrangement relationship with the master object, and a changing unit configured to change the position or the size of the master object and a position or a size of the at least one subordinate object according to the operation while maintaining the symmetric arrangement relationship between the master object and the at least one subordinate object.

### BACKGROUND OF THE DISCLOSURE

### Cross Reference to Priority Application

This application claims the benefit of Japanese Patent Application No. 2023-038398, filed on Mar. 13, 2023, which is hereby incorporated by reference wherein in its entirety.

### Field of the Disclosure

The present invention relates to a method of changing a layout of objects, an information processing apparatus, and a computer readable storage medium.

### Description of the Related Art

In the technical area of layout software that arranges and designs objects such as images and texts in an editing area on a screen, an object snapping technique is known that places a new object while aligning a reference portion or a margin thereof with that of an already placed object (for example, see Japanese Patent Laid-Open No. 2021-26705). By utilizing such object snapping during layout, it is possible to realize a design with a “symmetrical arrangement” of multiple objects. Furthermore, there is a technique for laying out images by applying them to slots in a template having a “symmetrical layout” prepared in advance. This allows a user to easily achieve the “symmetric arrangement” design.

However, if multiple objects are arranged in the “symmetric arrangement” design and then a position or a size of any object is changed, the “symmetric arrangement” design is not maintained. In such a case, the user needs to correct the layout after the change, and the usability is poor for the user.

### SUMMARY OF THE DISCLOSURE

One embodiment of the present disclosure is a non-transitory computer readable storage medium on which a computer program is recorded, the computer program, when executed, causing a computer to perform a method comprising: detecting an operation of changing a position or a size of a master object which is displayed on a screen; detecting at least one subordinate object which is displayed on the screen and in a symmetric arrangement relationship with the master object; and changing the position or the size of the master object and a position or a size of the at least one subordinate object according to the operation while maintaining the symmetric arrangement relationship between the master object and the at least one subordinate object.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a system;

FIG. 2 is a flowchart illustrating a processing of a poster editing application;

FIG. 3 is a diagram illustrating a screen of the application;

FIG. 4 is a diagram illustrating an environment setting screen;

FIG. 5 is a flowchart illustrating a processing in a first embodiment;

FIGS. 6A and 6B are respectively diagrams illustrating contents of an editing region in the first embodiment;

FIGS. 7A and 7B are respectively diagrams illustrating further contents of the editing region in the first embodiment;

FIGS. 8A and 8B are respectively diagrams illustrating still further contents of the editing region in the first embodiment;

FIG. 9 is a diagram illustrating a yet still further contents of the editing region in the first embodiment;

FIGS. 10A and 10B are respectively diagrams illustrating contents of an editing region in a second embodiment;

FIGS. 11A and 11B are respectively diagrams illustrating further contents of the editing region in the second embodiment;

FIGS. 12A and 12B are respectively diagrams illustrating still further contents of an editing region in a third embodiment;

FIGS. 13A and 13B are respectively diagrams illustrating contents of the editing region in the third embodiment;

FIG. 14 is a flowchart illustrating a processing in a fourth embodiment;

FIGS. 15A and 15B are respectively diagrams illustrating contents of an editing region in the fourth embodiment;

FIGS. 16A and 16B are respectively diagrams illustrating further contents of the editing region in the fourth embodiment; and

FIG. 17 is a diagram for explaining examples of the editing.

### DESCRIPTION OF THE EMBODIMENTS

Embodiments of the present disclosure are described below with respect to the attached drawings. Note that the present disclosure can be applied to layout software in general such as an object layout application, a poster editing application, a photo album editing application, and presentation creating software. In the embodiments of the present disclosure, explanation is given by using the poster editing application (Web application) as an example.

### First Embodiment

### Information Processing System

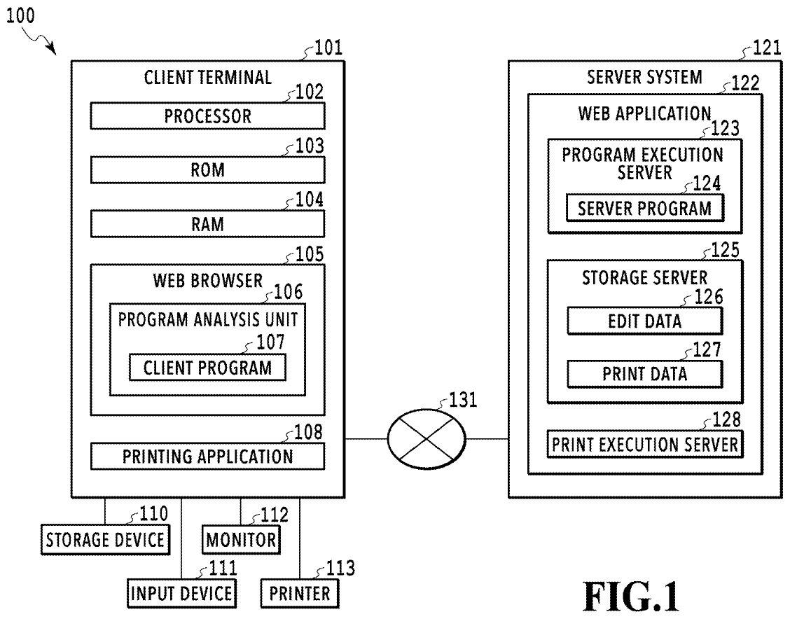

FIG. 1 is a configuration diagram of an information processing system 100 according to a technique of the present disclosure. In the information processing system 100, a client terminal 101 and a server system 121 operate in cooperation with each other via a network 131.

First, a configuration of the server system 121 used in the technique of the present disclosure is explained. A Web application 122 including a program execution server 123, a storage server 125, and a print execution server 128 is executed on the server system 121. The program execution server 123 executes a server program 124 that is a program configured to operate on the server system 121. Edit data 126 and print data 127 such as those in an image file and a print data file in the Web application are saved in the storage server 125. The print execution server 128 transmits the print data 127 to a printing application 108 in order to cause a printer 113 to perform printing. Note that the program execution server 123, the storage server 125, and the print execution server 128 may be implemented on physically separate apparatuses or on one apparatus.

Next, a configuration of the client terminal 101 used in the technique of the present disclosure is explained. The client terminal 101 is an information processing apparatus, and is formed of a general personal computer or a smartphone. The client terminal 101 includes a processor 102, a ROM 103, and a RAM 104. Moreover, the client terminal 101 includes an input-output interface (not illustrated) for connection with a storage device 110, an input device 111, a monitor 112, the printer 113, and the network 131 such as the Internet. The processor 102 is a central processing unit, and executes an OS stored in the storage device 110, the ROM 103, or the RAM 104 to control the entire the client terminal 101. Moreover, the processor 102 executes a Web browser 105, the printing application 108, and other programs stored in the ROM 103 and the RAM 104. In the execution of these programs, the processor 102 performs computation based on inputted data to process and output data, and controls pieces of hardware to implement the functions of the client terminal 101. The ROM 103 is a read-only memory, and the programs are stored in the ROM 103. The RAM 104 is a random access memory, and is used as a work memory of the processor 102. In a case where the RAM 104 is a non-volatile RAM, the programs may be stored in the RAM 104. The Web browser 105 is used for browsing of Web sites on the Internet, and executes the Web application 122. In a case where the Web browser 105 executes the Web application, the Web browser 105 receives a client program 107 from the server system 121, and executes the client program 107 in a program analysis unit 106 that interprets a script language such as HTML and JavaScript. The printing application 108 transmits the print data 127 to the printer 113 connected to the client terminal 101 directly or via the network 131 to perform printing.

The printer 113 executes printing based on print data created in the information processing system 100. The storage device 110 is a storage device such as an HDD or an SSD for storing image data, templates, and the like. The input device 111 is an input device such as a keyboard and a pointing device for performing input to the information processing system 100. Depending on a form of the input device, there is also a touch panel in which the input device 111 is integral with a monitor and the input is performed by direct touching of the monitor. The monitor 112 is a display device for displaying image information outputted by the information processing system 100. Note that the configuration illustrated in FIG. 1 is an example, and other forms may be used. For example, a configuration may be such that the client terminal 101 includes the storage device 110, the input device 111, and the monitor 112.

### Poster Editing Application

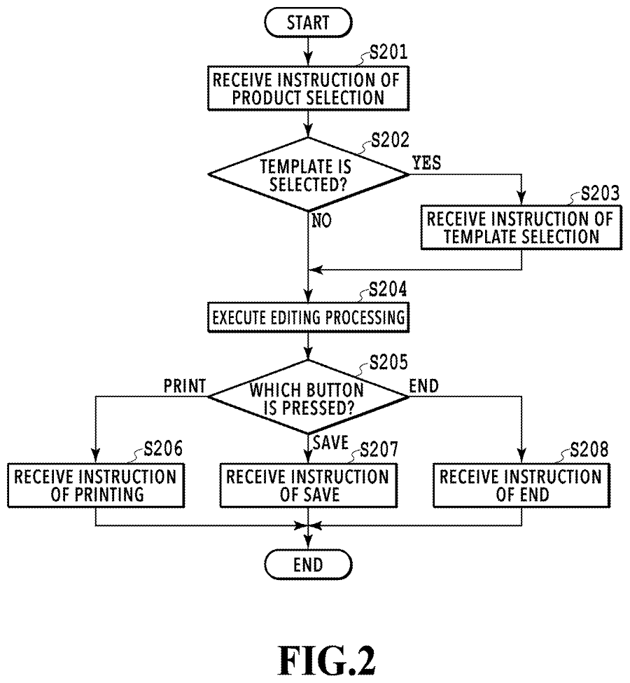

Next, processing of a poster editing application in the present embodiment is explained by using FIGS. 2 to 4.

In a case where a user activates a poster editing application 122 that is the Web application, the processing of FIG. 2 is started. Note that the processor 102 executes the steps of FIG. 2 by reading a program relating to the processing of the flowchart from the memory.

First, in step S201, the processor 102 receives an instruction of product selection made by the user, and sets a type of product (poster, flyer, calendar, and the like) according to an operation of the user. Hereinafter, “steps S” is abbreviated as “S”.

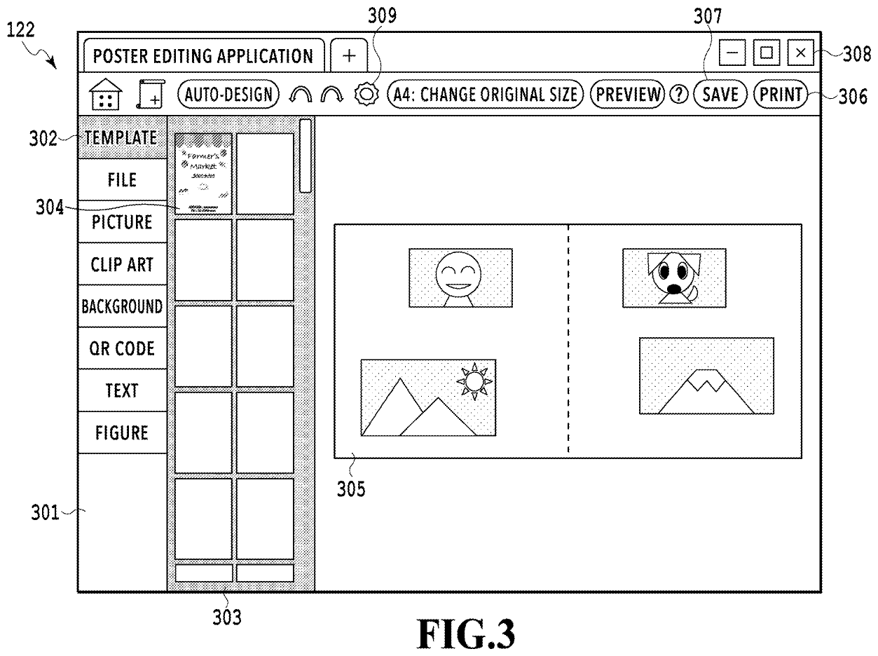

In S202, the processor 102 determines whether a template is selected according to an operation of the user in the poster editing application 122 of FIG. 3. In a case where the user selects a template selection button 302 in a category selection region 301, the processor 102 displays a list of templates in a template selection region 303. In a case where the user selects a template from this region, the determination result of S202 is true, and the processor 102 causes the processing to proceed to S203.

In S203, the processor 102 receives an instruction of the template selection, and displays poster data of the selected template in an editing region 305. FIG. 3 illustrates an example in a case where the user selects no template 304 from the template selection region 303 and performs layout arbitrarily. In a case where the processing of S203 is completed or the determination result of S202 is false, the processor 102 causes the processing to proceed to S204.

In S204, the processor 102 executes editing processing according to an operation of the user, and displays the poster data on the editing region 305 while reflecting the editing processing on the poster data. Specific examples of editing operations include addition, moving, and size change of objects and the like. In a case where the processing of S204 is completed, the processor 102 causes the processing to proceed to S205.

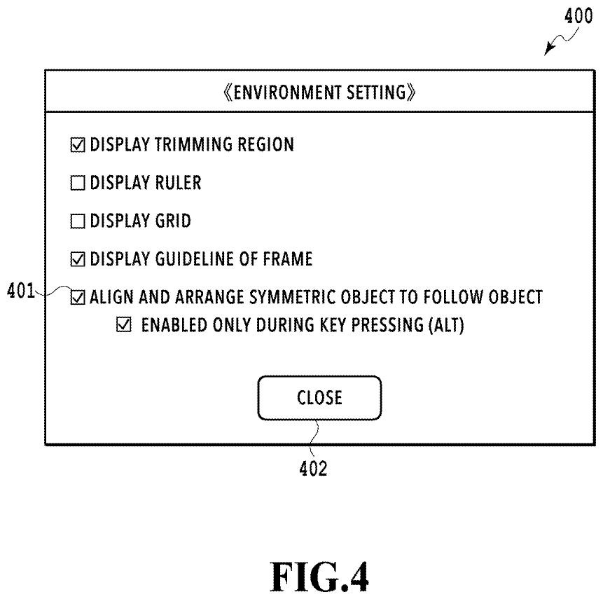

Note that the poster editing application 122 has an environment setting function in which display in a case where the user performs editing work can be switched according to preference. Examples of setting contents include display setting of a trimming region, display setting of grids and guidelines used as guides of arrangement in the editing region 305, and the like. An environment setting button 309 is used to switch the display in a case where the user performs editing work according to preference. In a case where the processor 102 receives pressing of the environment setting button 309, the processor 102 displays an environment setting screen 400 illustrated in FIG. 4, instead of the editing region 305 (or together with the editing region 305). Check boxes 401 of the environment setting screen 400 receive selection by the user. Moreover, in a case where the user presses a close button 402 after the setting through the environment setting screen 400, the processor 102 receives the user input, and transitions to the editing region 305. Note that items switchable in the environment setting screen 400 are not limited to the items illustrated in FIG. 4, and the items can be changed depending on the type of application.

In S205, the processor 102 determines which button is pressed according to an operation of the user. In a case when the determination result of the present step is printing, that is, in a case when pressing of a print button 306 is detected, the processing proceeds to S206, and the processor 102 receives an instruction of printing, and transmits the poster data to the printing application 108. Meanwhile, in a case where the determination result of the present step is save, that is, in a case where pressing of a save button 307 is detected, the processing proceeds to S207, and the processor 102 executes processing of saving the poster data. Moreover, in a case where the determination result of the present step is end, that is, in a case when pressing of an end button 308 is detected, the processing proceeds to S208, and the processor 102 receives an instruction of application end.

In a case where the processing of one of S206, S207, and S208 is completed, the processor 102 receives end of the poster editing processing, and completes the series of processes. That is the outline of the processing of the poster editing application.

### <Layout Control of Symmetric Objects>

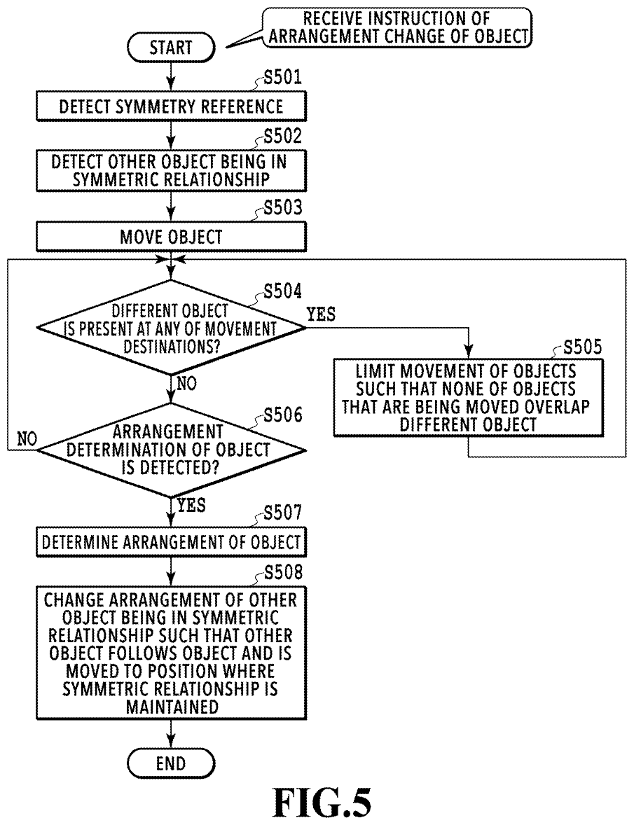

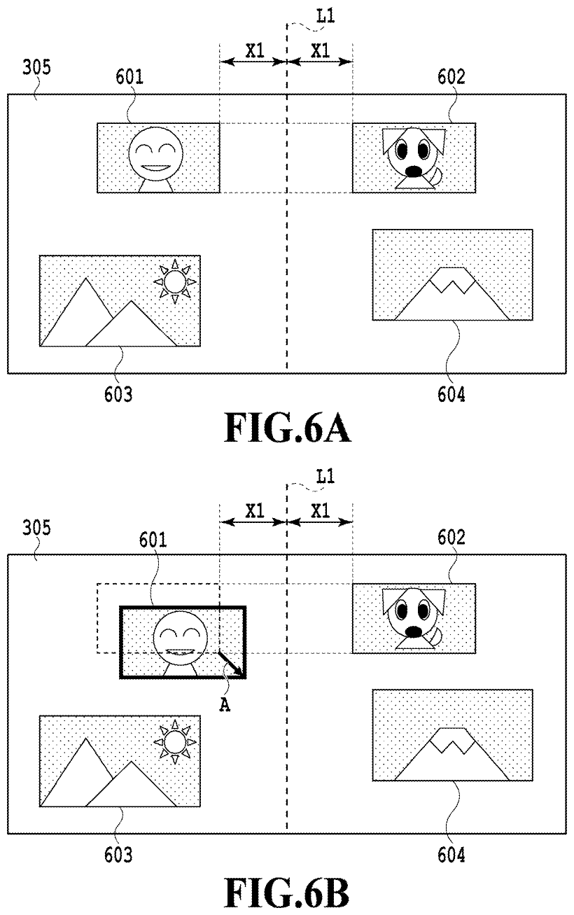

Next, layout control of symmetric objects that is a feature of the present embodiment is explained by using FIGS. 5 to 9. In this explanation, an object that is directly subjected to arrangement change processing is referred to as master object, and an object being in a predetermined symmetric arrangement relationship with the master object is referred to as subordinate object. In the present embodiment, in a case where the user performs the arrangement change processing on the master object, the subordinate object being in the symmetric arrangement relationship is aligned and arranged to follow the master object. Note that FIG. 5 is a flowchart illustrating processing of the present embodiment, and FIGS. 6A to 9 illustrate the editing region that transitions in object arrangement change in the present embodiment.

In the present embodiment, explanation is given by using, as an example, a case where, one object 601 out of objects 601 and 602 is subjected to arrangement change (moving) in a state where the objects 601 and 602 are symmetrically arranged in the editing region 305 as illustrated in FIG. 6A. In this example, the object 601 is the master object, and the object 602 is the subordinate object. Note that the objects 601 and 602 are prearranged left-right symmetric at positions where there are spaces X1 from a symmetry reference line L1 with the symmetry reference line L1 being a reference, the symmetry reference line L1 being a binding margin of a product. Moreover, in the present embodiment, as examples of the symmetrically arranged objects, the objects 601 and 602 are explained as objects that have the same size and are away from the symmetry reference line L1 by the same distance and whose positions in the up-down direction are aligned. However, the objects 601 and 602 are not limited to this. “Symmetrically arranged” in the present disclosure means that multiple objects may vary in size or in position in the up-down direction as long as the distances from the symmetry reference are the same.

The processing of FIG. 5 is started in a case where the arrangement change processing of an object by the user is detected. In this example, explanation is given by using the arrangement change processing on the object 601 as an example.

In S501, the processor 102 detects a symmetry reference of objects being in the symmetric arrangement relationship. For example, in the present embodiment, the symmetry reference line L1 in FIG. 6A is detected.

Next, in S502, the processor 102 detects a subordinate object being in the symmetric arrangement relationship with an object to be subjected to arrangement change. For example, in the present embodiment, the object 602 in FIG. 6A is detected. Note that execution of the steps of S501 and S502 is not limited to after the detection of the arrangement change processing, and the steps may be executed in advance.

Next, in S503, the processor 102 executes moving processing of the object 601. For example, as illustrated in FIG. 6B, the processor 102 moves the object 601 toward a lower-right corner of the screen in the A direction based on an operation of the user.

Next, in S504, the processor 102 determines whether a different object is present at or near any of movement destinations of the moving processing target object and the subordinate object being in the symmetric arrangement relationship. Specifically, the processor 102 determines whether a different object is present at or near any of movement destinations of the object 601 in FIG. 6B and the object 602 detected as the subordinate object being in the symmetric arrangement relationship in S502. For example, in a case where a different object is absent as illustrated in FIG. 6B, the determination result of S504 is false. In a case where the determination result of the present step is false, that is, in a case where a different object is absent, the processor 102 causes the processing to proceed to S506.

In S506, the processor 102 determines whether arrangement determination of the object is detected. For example, the processor 102 determines whether a drag-and-drop operation of the object 601 by the user is completed. In a case where the determination result of the present step is false, that is, in a case where the user is continuously performing the operation, the processor 102 causes the processing to return to the determination of S504 again. Meanwhile, in a case where the determination result of the present step is true, that is, in a case where the operation by the user is completed, the processor 102 causes the processing to proceed to S507.

In S507, the processor 102 completes the moving processing of the object 601, and determines the arrangement.

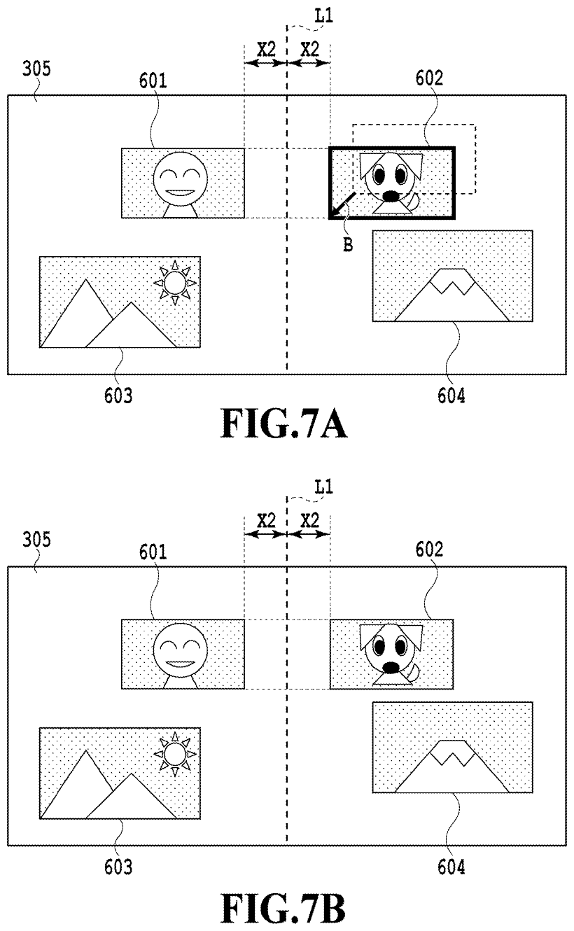

Next, in S508, the processor 102 changes the arrangement of the subordinate object 602 being in the symmetric arrangement relationship such that the subordinate object 602 follows the object 601 and is moved to a position where the symmetric arrangement relationship is maintained. In the present embodiment, as illustrated in FIG. 7A, the processor 102 moves the object 602 detected as the subordinate object being in the symmetric arrangement relationship in S502 toward the lower-left corner of the screen in the B direction (see FIG. 7A) such that the object 602 follows the object 601. In this case, the processor 102 arranges the object 602 such that the object 601 and the object 602 are left-right symmetric with respect to the symmetry reference line L1 with the same space X2 from the symmetry reference line L1. Accordingly, even in a case where the arrangement of the object 601 is changed, the symmetric arrangement relationship with the object 602 is maintained. Note that, although the processing of S508 is executed after the processing of S507 as an example in the present embodiment, the execution of the processing of S508 is not limited to this, and the processing of S508 may be executed during the moving processing of the object 601. Specifically, in a case where the user performs the moving operation of the object 601, the processor 102 may display the object 602 being in the symmetric arrangement relationship such that the object 602 is moved to follow the object 601, and determine the arrangement of the object 602 with the arrangement determination of the object 601.

In a case where the arrangement change processing of the objects is completed, the processing of the flowchart in FIG. 5 is completed, and the layout as illustrated in FIG. 7B is obtained. That is the flow of series of processes in the present embodiment.

Meanwhile, in a case where the determination result of S504 is true, that is, in a case where a different object is present at or near the movement destination of either of the objects, the processor 102 causes the processing to proceed to S505.

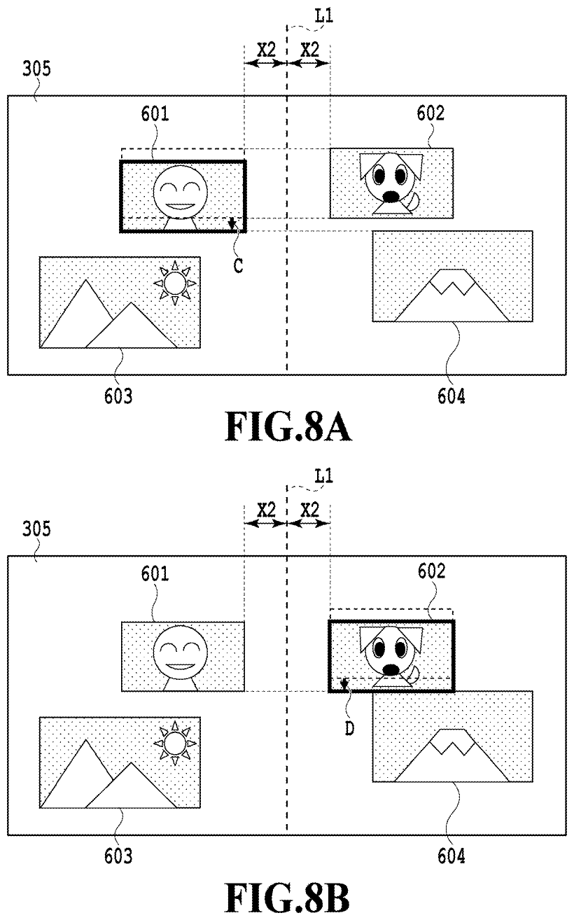

In S505, the processor 102 limits the movement of the objects such that the objects that are being moved do not overlap or come near the different object. For example, in a case where the object 601 is moved in the C direction as in FIG. 8A, a different object 604 is present at the movement destination of the object 602 following the object 601 as in FIG. 8B. In such a case, the processor 102 limits the movement such that the objects 601 and 602 cannot be moved downward.

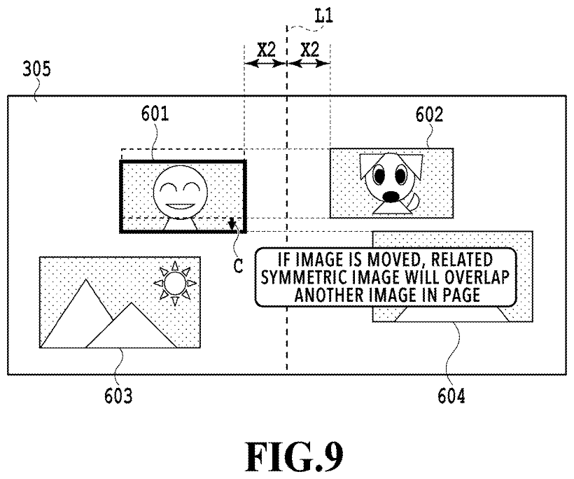

In this case, the processor 102 may display a warning message as illustrated in FIG. 9A.

Moreover, in the present embodiment, the present function may be achieved in combination with a key operation. For example, the configuration may be such that the combination with the key operation is set by using the check box 401 of the above-mentioned environment setting screen 400 illustrated in FIG. 4, and the object being in the symmetric arrangement relationship is aligned and arranged to follow the master object as in the present embodiment only while the “ALT” key is pressed.

### Effects of Present Embodiment

In the present embodiment, as descried above, in a case where the arrangement of any one of the objects aligned in symmetric arrangement in the left-right direction or the up-down direction is changed, the arrangement of the object relating to the object subjected to the arrangement change is changed to follow the object subjected to the arrangement change such that the symmetric arrangement relationship of the objects is maintained. Therefore, even in a case where the arrangement of the master object is changed, the symmetric arrangement of the master object and the subordinate object is maintained, and the usability in a case where the user performs the layout operation can be improved.

### Second Embodiment

Next, a second embodiment is explained. The present embodiment is different from the first embodiment in the reference of the symmetrical arrangement of the objects. Specifically, the first embodiment relates to the symmetric arrangement in which the vertical axis at the center of the editing region is the reference. However, the present embodiment relates to symmetric arrangement in which a horizontal axis at the center of the editing region or a center point of the editing region is the reference. Note that, in the following explanation, configurations similar to those in the above-mentioned embodiment are denoted by the same reference numerals and referred to by using the same names to omit iterated explanation as appropriate.

### Layout Control of Symmetric Objects

Layout control of the symmetric objects that is a feature of the present embodiment is explained below by using FIG. 5 and FIGS. 10A to 11B. In the present embodiment, in a case where the user performs the arrangement change processing on at least one of multiple symmetrically arranged objects, the subordinate objects being in the symmetric arrangement relationship are aligned and arranged to follow the object subjected to the arrangement change processing.

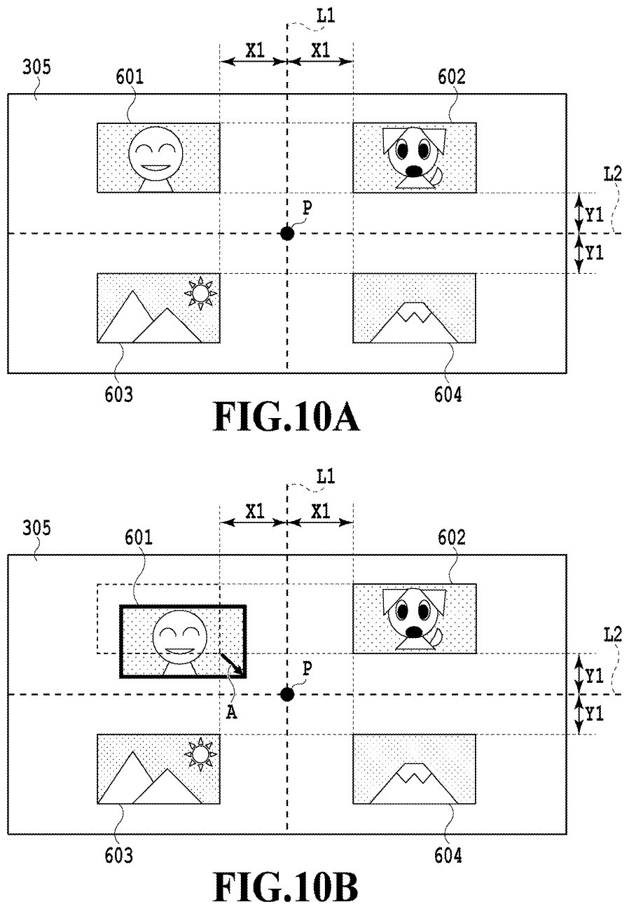

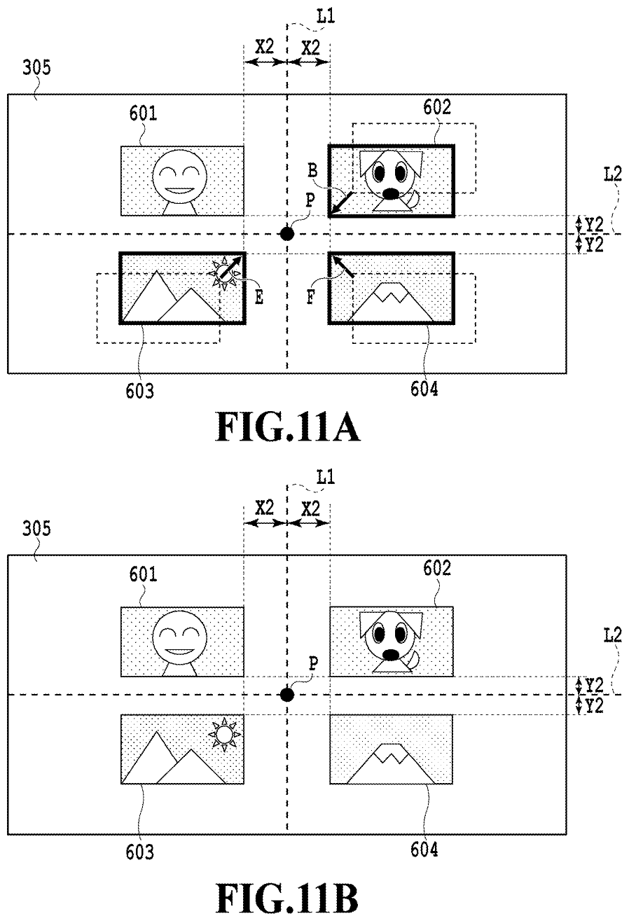

The basic processing in the present embodiment is the same as that in first embodiment, and is as illustrated in FIG. 5. FIGS. 10A to 11B illustrate the editing region that transitions in the object arrangement change in the present embodiment. Note that the processor 102 executes the steps of FIG. 5 by reading the program relating to the processing of the flowchart from the memory and processing the program. Moreover, since the series of processes of the poster editing application 122 is the same as the processing illustrated in FIG. 2, detailed explanation is not iterated.

In the present embodiment, explanation is given by using, as an example, a case where an object 601 is subjected to arrangement change (moving) in a state where objects 601 to 604 are symmetrically arranged in the left-right direction, the up-down direction, and oblique directions in the editing region 305 as illustrated in FIG. 10A. In this example, the object 601 is the master object, and the objects 602 to 604 are the subordinate objects. Note that the objects 601 and 602 are prearranged left-right symmetric at positions where there are spaces X1 from the symmetry reference line L1 with the symmetry reference line L1 being the reference. Similarly, the objects 603 and 604 are prearranged left-right symmetric at positions where there are spaces X1 from the symmetry reference line L1 with the symmetry reference line L1 being the reference. Moreover, the objects 601 and 603 are prearranged up-down symmetric at positions where there are spaces Y1 from a symmetry reference line L2 with the symmetry reference line L2 orthogonal to the symmetry reference line L1 being the reference. Similarly, the objects 602 and 604 are prearranged up-down symmetric at positions where there are spaces Y1 from the symmetry reference line L2 with the symmetry reference line L2 being the reference. Furthermore, the objects 601 and 604 are prearranged point symmetric at positions where there are spaces X1 from a symmetry reference point Pin the left-right direction with the symmetry reference point P being the reference and where there are spaces Y1 from the symmetry reference point P in the up-down direction with the symmetry reference point P being the reference. Similarly, the objects 602 and 603 are prearranged point symmetric at positions where there are spaces X1 from the symmetry reference point P in the left-right direction with the symmetry reference point P being the reference and where there are spaces Y1 from the symmetry reference point P in the up-down direction with the symmetry reference point P being the reference.

The processing of FIG. 5 is started in a case where the arrangement change processing of an object by the user is detected. In this example, explanation is given by using the arrangement change processing on the object 601 as an example.

In S501, the processor 102 detects the symmetry references of the objects being in the symmetric arrangement relationship. For example, in the present embodiment, the symmetry reference lines L1 and L2 and the symmetry reference point P in FIG. 10A are detected.

Next, in S502, the processor 102 detects subordinate objects being in the symmetric arrangement relationship with an object to be subjected to arrangement change. For example, in the present embodiment, the objects 602 to 604 in FIG. 10A are detected. Note that execution of the steps of S501 and S502 is not limited to after the detection of the arrangement change processing, and the steps may be performed in advance.

Next, in S503, the processor 102 executes moving processing of the object 601. For example, as illustrated in FIG. 10B, the processor 102 moves the object 601 toward a lower-right corner of the screen in the A direction based on an operation of the user.

Next, in S504, the processor 102 determines whether a different object is present at or near any of movement destinations of the moving processing target object and the subordinate objects being in the symmetric arrangement relationship. Specifically, the processor 102 determines whether a different object is present at or near any of movement destinations of the object 601 in FIG. 10B and the objects 602 to 604 detected as the subordinate objects being in the symmetric arrangement relationship in S502. For example, in a case where a different object is absent as illustrated in FIG. 10B, the determination result of S504 is false. In a case where the determination result of the present step is false, that is, in a case when a different object is absent, the processor 102 causes the processing to proceed to S506.

In S506, the processor 102 determines whether arrangement determination of the object is detected. For example, the processor 102 determines whether a drag-and-drop operation of the object 601 by the user is completed. In a case where the determination result of the present step is false, that is, in a case where the user is continuously performing the operation, the processor 102 causes the processing to return to the determination of S504 again. Meanwhile, in a case where the determination result of the present step is true, that is, in a case where the operation by the user is completed, the processor 102 causes the processing to proceed to S507.

In S507, the processor 102 completes the moving processing of the object 601, and determines the arrangement.

Next, in S508, the processor 102 changes the arrangement of the subordinate objects being in the symmetric arrangement relationship such that the subordinate objects follow the object 601 and are moved to positions where the symmetric arrangement relationship is maintained. For example, in the present embodiment, as illustrated in FIG. 11A, the processor 102 moves the objects 602 to 604 detected as the subordinate objects being in the symmetric arrangement relationship in S502 toward the center of the screen in the B direction, the E direction, and the F direction, respectively, such that the objects 602 to 604 follow the object 601. In this case, the processor 102 arranges the objects 602 to 604 such that the symmetric arrangement relationship similar to that before the movement is maintained also after the movement. Accordingly, even in a case where the arrangement of the object 601 is changed, the symmetric arrangement relationship of the object 601 with the objects 602 to 604 is maintained. Note that, although the processing of S508 is executed after the processing of S507 as an example in the present embodiment, the execution of the processing of S508 is not limited to this, and the processing of S508 may be executed during the moving processing of the object 601. Specifically, in a case where the user performs the moving operation of the object 601, the processor 102 displays the objects 602 to 604 being in the symmetric arrangement relationship such that the objects 602 to 604 are moved to follow the object 601. Then, the processor 102 may determine the arrangement of the objects 602 to 604 according to the arrangement determination of the object 601.

In a case where the arrangement change processing of the objects is completed, the processing of the flowchart in FIG. 5 is completed, and the layout as illustrated in FIG. 11B is obtained. That is the flow of series of processes in the present embodiment.

Since the processing in a case where the determination result of S504 is true, that is, in a case where a different object is present at or near any of the movement destinations of the objects is already explained in the first embodiment, explanation thereof is not iterated herein.

### Effects of Present Embodimen

In the present embodiment, as described above, in a case where the arrangement of any one of the objects aligned in symmetric arrangement in the left-right direction, the up-down direction, and the oblique directions is changed, the arrangements of the others of the objects, that is, the objects relating to the object subjected to the arrangement change are changed to follow the object subjected to the arrangement change such that the symmetric arrangement relationship of the objects is maintained. Therefore, even in a case where the arrangement of a master object which is any one of the symmetrically arranged objects is changed, the symmetric arrangement of the master object with the subordinate objects is thereby maintained and the usability in a case where the user performs the layout operation can be improved.

### Third Embodiment

Next, a third embodiment is explained. The present embodiment is different from the first embodiment in a target page. Specifically, in the first embodiment, a single page is the target. Meanwhile, the present embodiment relates to symmetrical objects laid across not only a single page but also multiple pages such as pages on two sides. Note that, in the following explanation, configurations similar to those in the above-mentioned embodiments are denoted by the same reference numerals and referred to by using the same names to omit iterated explanation as appropriate.

### Layout Control of Symmetric Objects Laid across Multiple Pages

The predetermined symmetric arrangement relationship described above is a symmetric arrangement relationship in two pages in a case the two pages are assumed to be one page. The two pages are, for example, a first cover and a back cover or, for example, two pages in a double page spread.

Layout control of the symmetric objects laid across multiple pages that is a feature of the present embodiment is explained below by using FIG. 5 and FIGS. 12A to 13B. In the present embodiment, in a case where the user performs the arrangement change processing on at least one of multiple symmetrically arranged objects laid across multiple pages, the subordinate object being in the symmetric arrangement relationship is aligned and arranged to follow the object subjected to the arrangement change processing.

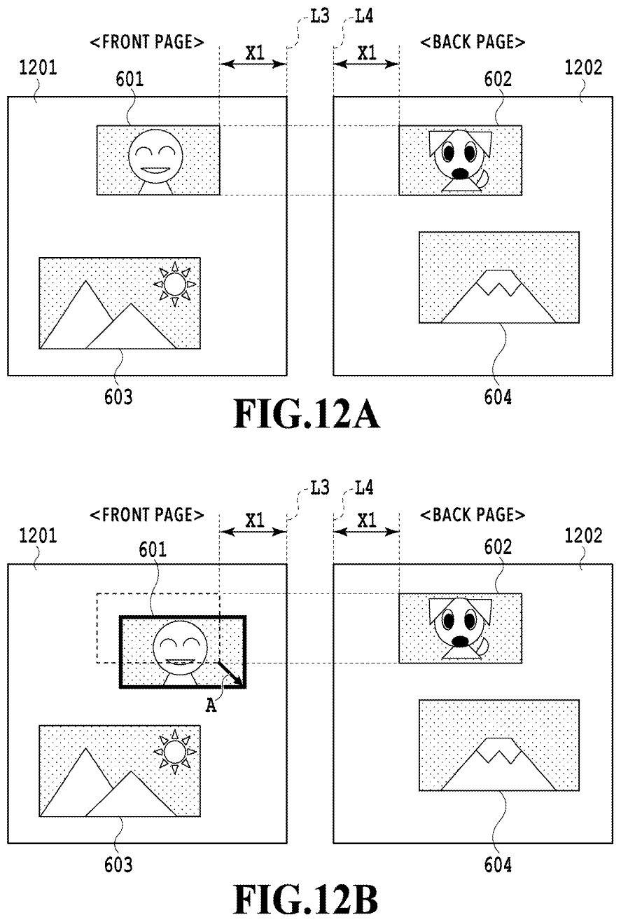

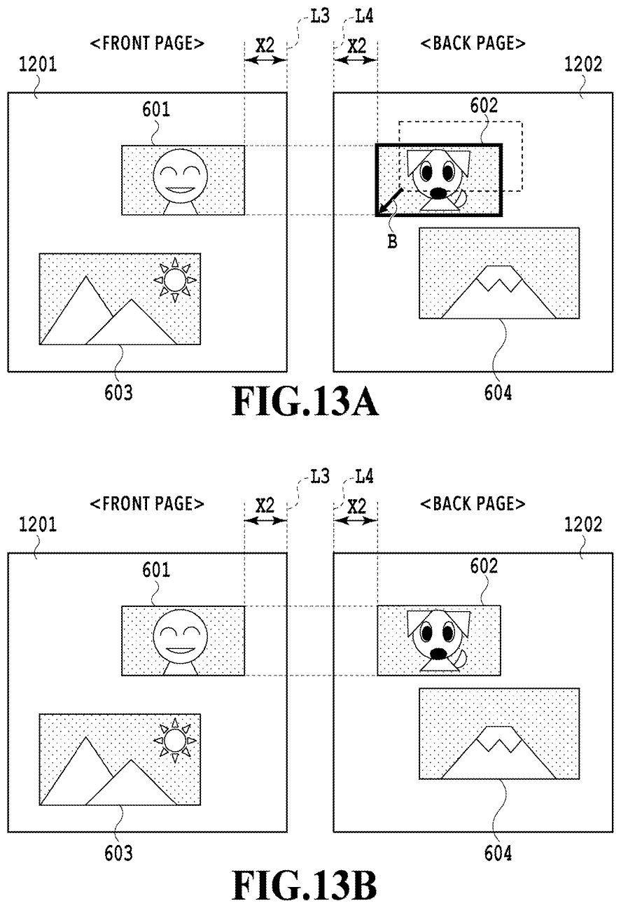

The basic processing in the present embodiment is the same as that in first embodiment, and is as illustrated in FIG. 5. FIGS. 12A to 13B illustrate the editing region that transitions in the object arrangement change in the present embodiment. Note that the processor 102 executes the steps of FIG. 5 by reading the program relating to the processing of the flowchart from the memory and processing the program. Moreover, since the series of processes of the poster editing application 122 is the same as the processing illustrated in FIG. 2, detailed explanation is not iterated.

In the present embodiment, explanation is given by using, as an example, a case where an object 601 is subjected to arrangement change in a state where objects 601 and 602 are arranged left-right symmetric across a front page 1201 and a back page 1202 of an editing region as illustrated in FIG. 12A. In this example, the object 601 is the master object, and the object 602 is the subordinate object. Note that the objects 601 and 602 are respectively prearranged left-right symmetric at positions where there are spaces X1 from symmetry reference lines L3 and L4 with the symmetry reference lines L3 and L4 being the references, the symmetry reference lines L3 and L4 being end portions of the respective pages.

The processing of FIG. 5 is started in a case where the arrangement change processing of an object by the user is detected. In this example, explanation is given by using the arrangement change processing on the object 601 as an example.

In S501, the processor 102 detects the symmetry references of the objects being in the symmetric arrangement relationship. For example, in the present embodiment, the symmetry reference lines L3 and L4 in FIG. 12A are detected.

Next, in S502, the processor 102 detects a subordinate object being in the symmetric arrangement relationship with an object to be subjected to arrangement change. For example, in the present embodiment, the object 602 in FIG. 12A is detected. Note that execution of the steps of S501 and S502 is not limited to after the detection of the arrangement change processing, and the steps may be performed in advance.

Next, in S503, the processor 102 executes moving processing of the object 601. For example, as illustrated in FIG. 12B, the processor 102 moves the object 601, which is a master object, toward the lower-right corner of the screen in the A direction based on an operation of the user.

Next, in S504, the processor 102 determines whether a different object is present at or near any of movement destinations of the moving processing target object and the subordinate object being in the symmetric arrangement relationship. Specifically, the processor 102 determines whether a different object is present at or near any of movement destinations of the object 601 in FIG. 12B and the object 602 detected as the subordinate object being in the symmetric arrangement relationship in S502. For example, in a case where a different object is absent as illustrated in FIG. 12B, the determination result of S504 is false. In a case where the determination result of the present step is false, that is, in a case where a different object is absent, the processor 102 causes the processing to proceed to S506.

In S506, the processor 102 determines whether arrangement determination of the object is detected. For example, the processor 102 determines whether a drag-and-drop operation of the object 601 by the user is completed. In a case where the determination result of the present step is false, that is, in a case where the user is continuously performing the operation, the processor 102 causes the processing to return to the determination of S504 again. Meanwhile, in a case where the determination result of the present step is true, that is, in a case where the operation by the user is completed, the processor 102 causes the processing to proceed to S507.

In S507, the processor 102 completes the moving processing of the object 601, and determines the arrangement.

Next, in S508, the processor 102 changes the arrangement of the subordinate object being in the symmetric arrangement relationship such that the subordinate object follows the object 601 and is moved to a position where the symmetric arrangement relationship is maintained. For example, in the present embodiment, as illustrated in FIG. 13A, the processor 102 moves the object 602 detected as the subordinate object being in the symmetric arrangement relationship in S502 toward the lower-left corner of the screen in the B direction such that the object 602 follows the object 601. In this case, the processor 102 arranges the object 602 such that the object 601 and the object 602 are left-right symmetric with respect to the symmetry reference lines L3 and L4 with the same space X2 from the symmetry reference lines L3 and L4, respectively. Accordingly, even in a case where the arrangement of the object 601 is changed, the symmetric arrangement relationship of the object 601 with the object 602 is maintained. Note that, although the processing of S508 is executed after the processing of S507 as an example in the present embodiment, the execution of the processing of S508 is not limited to this, and the processing of S508 may be executed during the moving processing of the object 601. Specifically, in a case where the user performs the moving operation of the object 601, the processor 102 may display the object 602 being in the symmetric arrangement relationship with the object 601 such that the object 602 is moved to follow the object 601, and determine the arrangement of the object 602 according to the arrangement determination of the object 601.

In a case where the arrangement change processing of the objects is completed, the processing of the flowchart in FIG. 5 is completed, and the layout as illustrated in FIG. 13B is obtained. That is the flow of series of processes in the present embodiment.

Since the processing in a case where the determination result of S504 is true, that is, in a case where a different object is present at or near any of the movement destinations of the objects is already explained in the first embodiment, explanation thereof is not iterated herein.

### Effects of Present Embodiment

In the present embodiment, as described above, in a case where the arrangement of any one of the objects aligned in symmetric arrangement is changed in not only one page but also multiple pages, the arrangements of the others of the objects, that is, the objects relating to the object subjected to the arrangement change are changed to follow the object subjected to the arrangement change such that the symmetric arrangement relationship of the objects is maintained. Therefore, even in a case where the arrangement of a master object which is any one of the symmetrically arranged objects is changed, the symmetric arrangement of the master object with the subordinate objects is thereby maintained and the usability in a case where the user performs the layout operation can be improved.

### Fourth Embodiment

Next, a fourth embodiment is explained. The present embodiment is different from the first embodiment in that the present disclosure is applied not to the arrangement change of the objects but also to size change. Note that, in the following explanation, configurations similar to those in the above-mentioned embodiments are denoted by the same reference numerals and referred to by using the same names to omit iterated explanation as appropriate. <Layout Control in Size Change of Symmetric Objects>

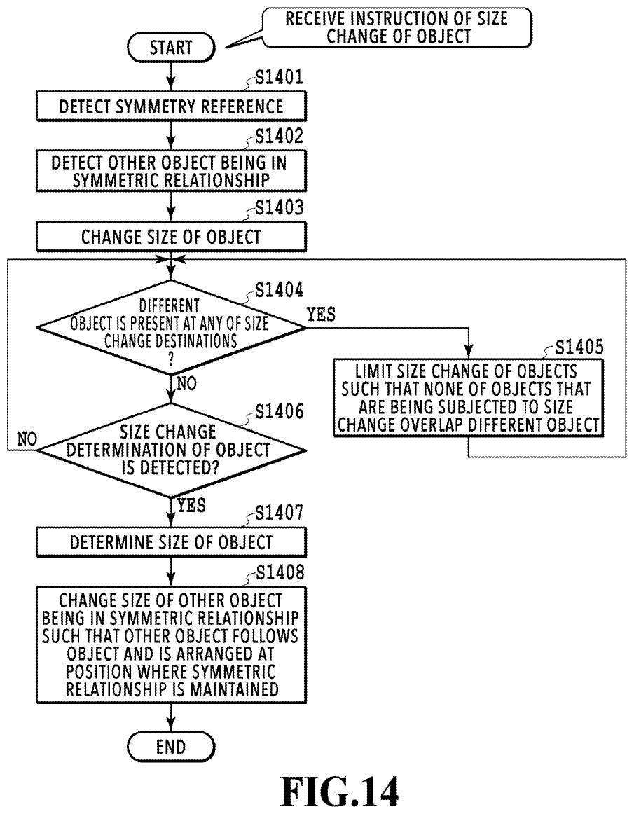

Layout control in the size change of symmetric objects that is a feature of the present embodiment is explained below by using FIG. 14 and FIGS. 15A to 16B. In the present embodiment, in a case where the user performs size change processing on at least one of multiple symmetrically-arranged objects, a subordinate object being in the symmetric arrangement relationship with the object subjected to the size change processing is aligned and arranged to follow the object subjected to the size change processing.

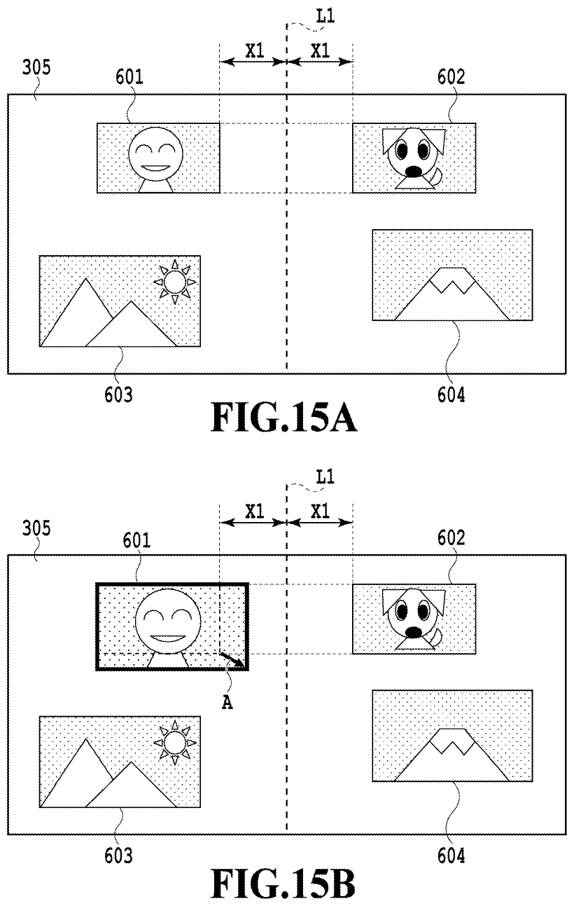

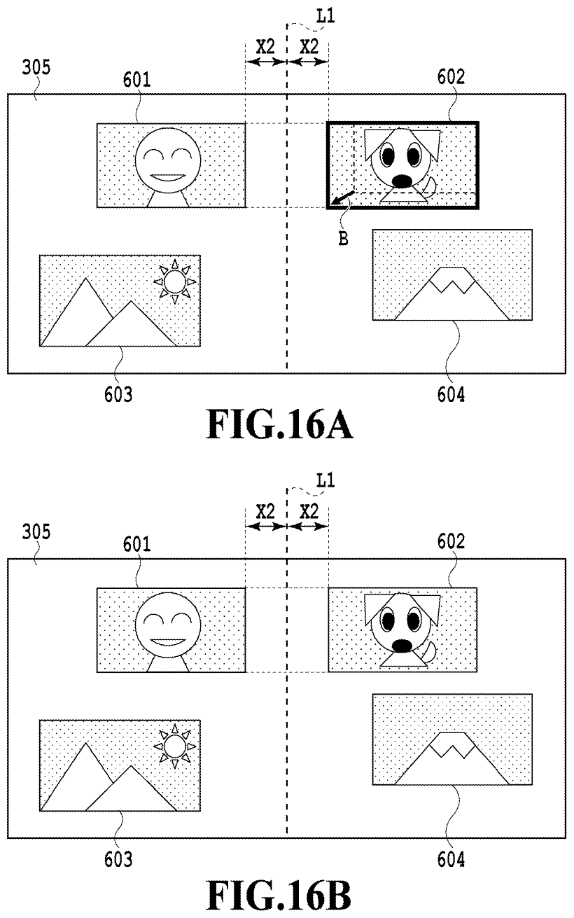

FIGS. 15A to 16B illustrate an editing region that transitions in the object size change in the present embodiment. Note that the processor 102 executes the steps of FIG. 14 by reading a program relating to the processing of the flowchart from the memory and processing the program. Moreover, since the series of processes of the poster editing application 122 is the same as the processing illustrated in FIG. 2, detailed explanation is not iterated.

In the present embodiment, explanation is given by using, as an example, a case where an object 601 is subjected to size change in a state where the objects 601 and 602 are arranged left-right symmetric in the editing region 305 as illustrated in FIG. 15A. In this example, the object 601 is a master object, and the object 602 is a subordinate object. Note that the objects 601 and 602 are prearranged left-right symmetric at positions where there are spaces X1 from the symmetry reference line L1 with the symmetry reference line L1 being the reference.

The processing of FIG. 14 is started in a case where the size change processing of an object by the user is detected. In this example, explanation is given by using the size change processing on the object 601 as an example.

In S1401, the processor 102 detects the symmetry reference of the objects being in the symmetric arrangement relationship. For example, in the present embodiment, the symmetry reference line L1 in FIG. 15A is detected.

Next, in S1402, the processor 102 detects a subordinate object being in the symmetric arrangement relationship with an object to be subjected to size change. For example, in the present embodiment, the object 602 in FIG. 15A is detected. Note that execution of the steps of S1401 and S1402 is not limited to after the detection of the size change processing, and the steps may be performed in advance.

Next, in S1403, the processor 102 executes the size change processing of the object 601. For example, as illustrated in FIG. 15B, the processor 102 changes (enlarges) the size of the object 601 toward the lower-right corner of the screen in the A direction based on an operation of the user. Specifically, the processor 102 moves the coordinates of the lower-right corner of the object 601 toward the lower-right side while maintaining the coordinates of the upper-left corner.

Next, in S1404, the processor 102 determines whether a different object is present at or near any of size change destinations of the size change processing target object and the subordinate object being in the symmetric arrangement relationship. Specifically, the processor 102 determines whether a different object is present at or near size any of change destinations of the object 601 in FIG. 15B and the object 602 detected as the subordinate object being in the symmetric arrangement relationship in S1402. For example, in a case where a different object is absent as illustrated in FIG. 15B, the determination result of S1404 is false. In a case where the determination result of the present step is false, that is, in a case when a different object is absent, the processor 102 causes the processing to proceed to S1406.

In S1406, the processor 102 determines whether size change determination of the object is detected. For example, the processor 102 determines whether a drag-and-drop operation of the object 601 by the user is completed. In a case where the determination result of the present step is false, that is, in a case where the user is continuously performing the operation, the processor 102 causes the processing to return to the determination of S1404 again. Meanwhile, in a case where the determination result of the present step is true, that is, in a case where the operation by the user is completed, the processor 102 causes the processing to proceed to S1407.

In S1407, the processor 102 completes the size change processing of the object 601, and determines the size.

Next, in S1408, the processor 102 changes the size of the subordinate object 602 being in the symmetric arrangement relationship with the object 601 such that the subordinate object 602 follows the object 601 and is arranged at a position where the symmetric arrangement relationship is maintained. For example, in the present embodiment, as illustrated in FIG. 16A, the processor 102 changes the size of the object 602 detected as the subordinate object being in the symmetric arrangement relationship with the object 601 in S1402 toward the lower-left corner of the screen in the B direction such that the object 602 follows the object 601. Specifically, the processor 102 moves the coordinates of the lower-left corner of the object 602 toward the lower-right side while maintaining the coordinates of the upper-right corner. In this case, the processor 102 changes the size of the object 602 such that the object 601 and the object 602 are left-right symmetric with respect to the symmetry reference line L1 with the same space X2 from the symmetry reference line L1. Accordingly, even in a case where the size of the object 601 is changed, the symmetric arrangement relationship of the object 601 with the object 602 is maintained. Note that, although the processing of S1408 is executed after the processing of S1407 as an example in the present embodiment, the execution of the processing of S1408 is not limited to this, and the processing of S1408 may be executed during the size change processing of the object 601. Specifically, in a case when the user performs the size change operation of the object 601, the processor 102 can display the object 602 being in the symmetric arrangement relationship such that the object 602 is subjected to size change to follow the object 601. Then, the processor 102 may determine the size change of the object 602 according to the size change determination of the object 601.

In a case where the size change processing of the objects is completed, the processing of the flowchart in FIG. 14 is completed, and the layout as illustrated in FIG. 16B is obtained. That is, the flow of series of processes in the present embodiment.

Meanwhile, in a case where the determination result of $1404 is true, that is, in a case where a different object is present at or near any of the size change destinations of the objects, the processor 102 causes the processing to proceed to S1405. Since the processing of S1405 is the same as that in the first embodiment, explanation thereof is not iterated herein.

### Effects of Present Embodiment

In the present embodiment, as descried above, in a case where the size of any one of the objects aligned in symmetric arrangement in the left-right direction or the up-down direction is changed, the size of the object relating to the object subjected to the size change is changed to follow the object subjected to the size change such that the symmetric arrangement relationship of the objects is maintained. Therefore, even in a case where the size of the master object is changed, the symmetric arrangement of the master object and the subordinate object is maintained, and the usability in a case where the user performs the layout operation can be improved.

### Other Embodiments

The first embodiment is an embodiment relating to movement of two objects in the left-right symmetric arrangement relationship with respect to the vertical symmetry reference line L1. The first embodiment can be modified to an embodiment relating to movement of two objects in the up-down symmetric arrangement relationship with respect to the horizontal symmetry reference line L2.

The second embodiment is an embodiment relating to movement of four objects in the left-right and up-down symmetric arrangement relationships with respect to the vertical symmetry reference line L1 and the horizontal symmetry reference line L2.

The third embodiment is a modification of the first embodiment configured to correspond to two objects arranged across two pages. The third embodiment may be modified to an embodiment corresponding to four objects arranged in upper, lower, left, and right portions across two pages.

The fourth embodiment is an embodiment relating to size change of two objects in the left-right symmetric arrangement relationship with respect to the vertical symmetry reference line L1. The fourth embodiment can be modified to an embodiment relating to size change of four objects in the left-right and up-down symmetric arrangement relationships with respect to the vertical symmetry reference line L1 and the horizontal symmetry reference line L2.

The above-mentioned embodiments are explained to be executed by using the poster editing application 122. However, an application to which the idea of the present disclosure can be applied is not limited to the poster editing application. For example, the idea can be applied to layout software in general such as a layout editing application, an album editing application, and presentation creation software that newly arrange object data.

All of the four objects in the left-right and up-down symmetric relationships with respect to the vertical symmetry reference line L1 and the horizontal symmetry reference line L2 may be changed to at least two objects. For example, the four object may be changed to two objects in a point symmetric arrangement relationship with respect to an intersection of the vertical symmetry reference line L1 and the horizontal symmetry reference line L2. Then, these two objects may be moved or subjected to size change with the symmetric arrangement relationship of the two objects maintained.

In the example illustrated in FIGS. 15A to 16B, a vertex on a diagonal line drawn from a selected vertex is used as a reference point, and this reference point is not moved. However, the present disclosure is not limited to this. For example, the configuration may be such that the center point of the object is used as the reference point, and this reference point is not moved. The same applies to the subordinate object being in the symmetric arrangement relationship.

### Example 1

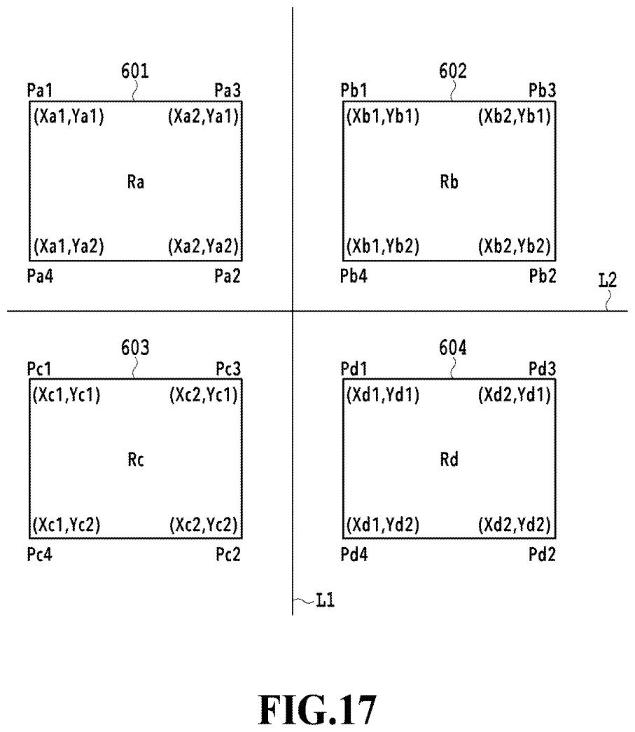

Specific examples of steps S507 and S508 (see FIG. 5) are explained with reference to FIG. 17.

### (1) Movement, Line Symmetric (Corresponding to First Embodiment)

The coordinates of each point in the editing region 305 are expressed as follows:
A vertex Pa1 at an upper-left corner of a rectangle Ra defining the position and the size of the object 601 before movement: (Xa1, Ya1);
A vertex Pa2 at a lower-right corner of the rectangle Ra defining the position and the size of the object 601 before the movement: (Xa2, Ya2);
A vertex Pb1 at an upper-left corner of a rectangle Rb defining the position and the size of the object 602 before the movement: (Xb1, Yb1);
A vertex Pb2 at a lower-right corner of the rectangle Rb defining the position and the size of the object 602 before the movement: (Xb2, Yb2);
A vertex P′a1 at an upper-left corner of a rectangle R′a defining the position and the size of the object 601 after the movement: (X′a1, Y′a1);
A vertex P′a2 at a lower-right corner of the rectangle R′a defining the position and the size of the object 601 after the movement: (X′a2, Y′a2);
A vertex P′b1 at an upper-left corner of a rectangle R′b defining the position and the size of the object 602 after the movement: (X′b1, Y′b1); and
A vertex P′b2 at a lower-right corner of the rectangle R′b defining the position and the size of the object 602 after the movement: (X′b2, Y′b2).

In this case, if the relationships of the objects 601 and 602 before and after the movement are expressed by using:
a movement amount ΔMa (ΔXa, ΔYa) of the object 601, and
a movement amount ΔMb (ΔXb, ΔYb) of the object 602, the expression is as follows:

$$Vertex {P}^{′} a 1 = vertex Pa 1 + Δ Ma ;$$

$$Vertex {P}^{′} b 1 = vertex Pb 1 + Δ Mb .$$

In this case, if the line symmetric positional relationship of the objects 601 and 602 with respect to the straight line L1 is to be maintained,

$$Δ Xb = - Δ Xa ;$$

$$and$$

$$Δ Yb = Δ Ya$$

should be satisfied. Accordingly,

$$Δ Mb ( Δ Xb , Δ Yb ) = Δ Mb ( - Δ Xa , Δ Ya ) .$$

Thus, the relationships of:

$$vertex {P}^{′} a 1 ( {X}^{′} a 1 , {Y}^{′} a 1 ) = ( Xa 1 + Δ Xa , Ya 1 + Δ Ya ) ,$$

$$vertex {P}^{′} a 2 ( {X}^{′} a 2 , {Y}^{′} a 2 ) = ( Xa 2 + Δ Xa , Ya 2 + Δ Ya ) ,$$

$$vertex {P}^{′} b 1 ( {X}^{′} b 1 , {Y}^{′} b 1 ) = ( Xb 1 - Δ Xa , Yb 1 + Δ Ya ) ,$$

$$and$$

$$vertex {P}^{′} b 2 ( {X}^{′} b 2 , {Y}^{′} b 2 ) = ( Xb 2 - Δ Xa , Yb 2 + Δ Ya )$$

are satisfied. Specifically, in steps S507 and S508, the objects 601 and 602 are moved to satisfy the following conditions:
A component of the movement vector ΔMa of the reference vertex Pa1 (or vertex Pa2) in the object 601 parallel to the reference line L1 and a component of the movement vector ΔMb of the reference vertex Pb1 (or vertex Pb2) in the object 602 parallel to the reference line L1 are identical to each other.
A component of the movement vector ΔMa of the reference vertex Pa1 (or vertex Pa2) in the object 601 perpendicular to the reference line L1 and a component of the movement vector ΔMb of the reference vertex Pb1 (or vertex Pb2) in the object 602 perpendicular to the reference line L1 are same in magnitude and opposite in direction.

### (2) Movement, Cross Symmetric (Corresponding to Second Embodiment)

The coordinates of each point in the editing region 305 are expressed as follows:
A vertex Pa1 at an upper-left corner of a rectangle Ra defining the position and the size of the object 601 before movement: (Xa1, Ya1);
A vertex Pa2 at a lower-right corner of the rectangle Ra defining the position and the size of the object 601 before the movement: (Xa2, Ya2);
A vertex Pb1 at an upper-left corner of a rectangle Rb defining the position and the size of the object 602 before the movement: (Xb1, Yb1);
A vertex Pb2 at a lower-right corner of the rectangle Rb defining the position and the size of the object 602 before the movement: (Xb2, Yb2);
A vertex Pc1 at an upper-left corner of a rectangle Rc defining the position and the size of the object 603 before the movement: (Xc1, Yc1);
A vertex Pc2 at a lower-right corner of the rectangle Rc defining the position and the size of the object 603 before the movement: (Xc2, Yc2);
A vertex Pd1 at an upper-left corner of a rectangle Rd defining the position and the size of the object 604 before the movement: (Xd1, Yd1);
A vertex Pd2 at a lower-right corner of the rectangle Rd defining the position and the size of the object 604 before the movement: (Xd2, Yd2);
A vertex P′a1 at an upper-left corner of a rectangle R′a defining the position and the size of the object 601 after the movement: (X′a1, Y′a1);
A vertex P′a2 at a lower-right corner of the rectangle R′a defining the position and the size of the object 601 after the movement: (X′a2, Y′a2);
A vertex P′b1 at an upper-left corner of a rectangle R′b defining the position and the size of the object 602 after the movement: (X′b1, Y′b1);
A vertex P′b2 at a lower-right corner of the rectangle R′b defining the position and the size of the object 602 after the movement: (X′b2, Y′b2);
A vertex P′c1 at an upper-left corner of a rectangle R′c defining the position and the size of the object 603 after the movement: (X′c1, Y′c1);
A vertex P′c2 at a lower-right corner of the rectangle R′c defining the position and the size of the object 603 after the movement: (X′c2, Y′c2);
A vertex P′d1 at an upper-left corner of a rectangle R′d defining the position and the size of the object 604 after the movement: (X′d1, Y′d1); and
A vertex P′d2 at a lower-right corner of the rectangle R′d defining the position and the size of the object 604 after the movement: (X′d2, Y′d2).

In this case, if the relationships of the objects 601 to 604 before and after the movement are expressed by using:
a movement amount ΔMa (ΔXa, ΔYa) of the object 601,
a movement amount ΔMb (ΔXb, ΔYb) of the object 602,
a movement amount ΔMc (ΔXc, ΔYc) of the object 603, and
a movement amount ΔMd (ΔXd, ΔYd) of the object 604,
   the expression is as follows:

$$Vertex {P}^{′} a 1 = vertex Pa 1 + Δ Ma$$

$$Vertex {P}^{′} b 1 = vertex Pb 1 + Δ Mb$$

$$Vertex {P}^{′} c 1 = vertex Pc 1 + Δ Mc$$

$$Vertex {P}^{′} d 1 = vertex Pd 1 + Δ Md$$

In this case, if the line symmetric positional relationship of the objects 601 and 602 with respect to the straight line L1 is to be maintained,

$$Δ Xb = - Δ Xa ,$$

$$and$$

$$Δ Yb = Δ Ya .$$

should be satisfied. Accordingly,

movement amount ΔMb (ΔXb, ΔYb)=ΔMb (−ΔXa, ΔYa).

Moreover, if the line symmetric positional relationship of the objects 601 and 603 with respect to the straight line L2 is to be maintained,

$$Δ Xc = Δ Xa ,$$

$$and$$

$$Δ Yc = - Δ Ya .$$

should be satisfied. Accordingly,

movement amount ΔMc (ΔXc, ΔYc)=ΔMc(ΔXa,−ΔYa).

Furthermore, if the point symmetric positional relationship of the objects 601 and 604 with respect to the vertex P is to be maintained,

$$Δ Xd = - Δ Xa ,$$

$$and$$

$$Δ Yd = - Δ Ya .$$

should be satisfied. Accordingly,

movement amount ΔMd (ΔXd, ΔYd)=ΔMd(−ΔXa,−ΔYa).

Thus, the relationships of

$$\begin{matrix}vertex {P}^{′} a 1 ( {X}^{′} a 1 , {Y}^{′} a 1 ) = ( Xa 1 + Δ Xa , Ya 1 + Δ Ya ) , \\ vertex {P}^{′} a 2 ( {X}^{′} a 2 , {Y}^{′} a 2 ) = ( Xa 2 + Δ Xa , Ya 2 + Δ Ya ) , \\ vertex {P}^{′} b 1 ( {X}^{′} b 1 , {Y}^{′} b 1 ) = ( Xb 1 - Δ Xa , Yb 1 + Δ Ya ) , \\ vertex {P}^{′} b 2 ( {X}^{′} b 2 , {Y}^{′} b 2 ) = ( Xb 2 - Δ Xa , Yb 2 + Δ Ya ) , \\ vertex {P}^{′} c 1 ( {X}^{′} c 1 , {Y}^{′} c 1 ) = ( Xc 1 + Δ Xa , Yc 1 - Δ Ya ) , \\ vertex {P}^{′} c 2 ( {X}^{′} c 2 , {Y}^{′} c 2 ) = ( Xc 2 + Δ Xa , Yc 2 - Δ Ya ) , \\ vertex {P}^{′} d 1 ( {X}^{′} d 1 , {Y}^{′} d 1 ) = ( Xd 1 - Δ Xa , Yd 1 - Δ Ya ) , and \\ vertex {P}^{′} d 2 ( {X}^{′} d 2 , {Y}^{′} d 2 ) = ( Xd 2 - Δ Xa , Yd 2 - Δ Ya ) ,\end{matrix}$$

are satisfied. Specifically, in steps S507 and S508, the objects 601, 602, 603, and 604 are moved to satisfy the following conditions.
A component of the movement vector ΔMa of the reference vertex Pa1 (or vertex Pa2) in the object 601 parallel to the reference line L1 and a component of the movement vector ΔMb of the reference vertex Pb1 (or vertex Pb2) in the object 602 parallel to the reference line L1 are identical to each other.
A component of the movement vector ΔMa of the reference vertex Pa1 (or vertex Pa2) in the object 601 perpendicular to the reference line L1 and a component of the movement vector ΔMb of the reference vertex Pb1 (or vertex Pb2) in the object 602 perpendicular to the reference line L1 are same in magnitude and opposite in direction.
A component of the movement vector ΔMa of the reference vertex Pa1 (or vertex Pa2) in the object 601 parallel to the reference line L2 and a component of the movement vector ΔMc of the reference vertex Pc1 (or vertex Pc2) in the object 603 parallel to the reference line L2 are identical in magnitude.
A component of the movement vector ΔMa of the reference vertex Pa1 (or vertex Pa2) in the object 601 perpendicular to the reference line L2 and a component of the movement vector ΔMc of the reference vertex Pc1 (or vertex Pc2) in the object 603 perpendicular to the reference line L2 are same in magnitude and opposite in direction.
The component of the movement vector ΔMa of the reference vertex Pa1 (or vertex Pa2) in the object 601 parallel to the reference line L1 and a component of the movement vector ΔMd of the reference vertex Pdl (or vertex Pd2) in the object 604 parallel to the reference line L1 are same in magnitude and opposite in direction.
The component of the movement vector ΔMa of the reference vertex Pa1 (or vertex Pa2) in the object 601 perpendicular to the reference line L1 and a component of the movement vector ΔMd of the reference vertex Pdl (or vertex Pd2) in the object 604 perpendicular to the reference line L1 are same in magnitude and opposite in direction.

Note that the above-mentioned coordinates are stored in the RAM 104 included in the client terminal 101 to be readable and writable. Moreover, the movement amounts are also stored in the RAM 104 included in the client terminal 101 to be readable and writable. The processor 102 included in the client terminal 101 can execute computation between the above-mentioned coordinates and movement amounts. Moreover, the processor 102 included in the client terminal 101 can determine the movement amounts according to an operation performed on the input device 111 such as a pointing device. The processor 102 included in the client terminal 101 has a function of drawing objects in the editing region 305 based on the above-mentioned coordinates upon receiving the coordinates. The same applies also to Example 2 described below.

### Example 2

Specific examples of steps S1407 and S1408 (see FIG. 14) are explained with reference to FIG. 17.

### (1) Size Change, Line Symmetric

The coordinates of each point in the editing region 305 are expressed as follows:
A vertex Pa1 at an upper-left corner of a rectangle Ra defining the position and the size of the object 601 before size change: (Xa1, Ya1)
A vertex Pa2 at a lower-right corner of the rectangle Ra defining the position and the size of the object 601 before the size change: (Xa2, Ya2)
A vertex Pa3 at an upper-right corner of the rectangle Ra defining the position and the size of the object 601 before the size change: (Xa2, Ya1)
A vertex Pa4 at a lower-left corner of the rectangle Ra defining the position and the size of the object 601 before the size change: (Xa1, Ya2)
A vertex Pb1 at an upper-left corner of a rectangle Rb defining the position and the size of the object 602 before the size change: (Xb1, Yb1)
A vertex Pb2 at a lower-right corner of the rectangle Rb defining the position and the size of the object 602 before the size change: (Xb2, Yb2)
A vertex Pb3 at an upper-right corner of the rectangle Rb defining the position and the size of the object 602 before the size change: (Xb2, Yb1)
A vertex Pb4 at a lower-left corner of the rectangle Rb defining the position and the size of the object 602 before the size change: (Xb1 Yb2)
A vertex P′a1 at an upper-left corner of a rectangle R′a defining the position and the size of the object 601 after the size change: (X′a1, Y′a1)
A vertex P′a2 at a lower-right corner of the rectangle R′a defining the position and the size of the object 601 after the size change: (X′a2, Y′a2)
A vertex P′a3 at an upper-right corner of the rectangle R′a defining the position and the size of the object 601 after the size change: (X′a2, Y′a1)
A vertex P′a4 at a lower-left corner of the rectangle R′a defining the position and the size of the object 601 after the size change: (X′a1, Y′a2)
A vertex P′b1 at an upper-left corner of a rectangle R′b defining the position and the size of the object 602 after the size change: (X′b1, Y′b1)
A vertex P′b2 at a lower-right corner of the rectangle R′b defining the position and the size of the object 602 after the size change: (X′b2, Y′b2)
A vertex P′b3 at an upper-right corner of the rectangle R′b defining the position and the size of the object 602 after the size change: (X′b2, Y′b1)
A vertex P′b4 at a lower-left corner of the rectangle R′b defining the position and the size of the object 602 after the size change: (X′b1, Y′b2)

In this case, if the relationships of the selected point and the point corresponding to the selected point in the objects 601 and 602 before and after the size change are expressed by using
a movement amount ΔMa (ΔXa, ΔYa) of the selected vertex Pax (Pa1, Pa2, Pa3, or Pa4) in the object 601, and
a movement amount ΔMb (ΔXb, ΔYb) of the vertex Pbx (Pb1, Pb2, Pb3, or Pb4) corresponding to the selected vertex Pax in the object 602,
   the expression is as follows.

$$\begin{matrix}Vertex {P}^{′} ax = vertex Pax + Δ Ma \\ Vertex {P}^{′} bx = vertex Pbx + Δ Mb\end{matrix}$$

Note that, assuming that the reference line is the vertical line L1, in a case where the selected vertex Pax is Pa1, the corresponding vertex Pbx is Pb3. In a case where the selected vertex Pax is Pa2, the corresponding vertex Pbx is Pb4. In a case where the selected vertex Pax is Pa3, the corresponding vertex Pbx is Pb1. In a case where the selected vertex Pax is Pa4, the corresponding vertex Pbx is Pb2.

Moreover, assuming that the reference line is the horizontal line L2, the object 603 corresponds to the object 601. In a case where the selected vertex Pax is Pa1, the corresponding vertex Pcx is Pc4. In a case where the selected vertex Pax is Pa2, the corresponding vertex Pcx is Pc3. In a case where the selected vertex Pax is Pa3, the corresponding vertex Pcx is Pc2. In a case where the selected vertex Pax is Pa4, the corresponding vertex Pcx is Pc1.

In any case, the reference point that is another vertex on the diagonal line drawn from the selected vertex and another vertex on the diagonal line drawn from the vertex corresponding to the selected vertex do not move. The same applies also to (2) described later.

Hereinafter, the reference line is assumed to be the vertical line L1.

In this case, if the line symmetric positional relationship of the objects 601 and 602 with respect to the straight line L1 is to be maintained,

$$\begin{matrix}Δ Xb = - ΔXa , and \\ Δ Yb = Δ Ya\end{matrix}$$

should be satisfied. Accordingly,

movement amount ΔMb (ΔXb, ΔYb)=ΔMb(−ΔXa, ΔYa).

Thus,

$$\begin{matrix}vertex {P}^{′} ax ( {X}^{′} ax , {Y}^{′} ax ) = ( Xax + Δ X a , Y a x + Δ Ya ) , and \\ vertex {P}^{′} bx ( {X}^{′} bx , {Y}^{′} bx ) = ( Xbx - Δ X a , Y b x + Δ Ya ) .\end{matrix}$$

In this case, for example, if the selected vertex Pax is the vertex Pa2, the relationship of

$$\begin{matrix}vertex {P}^{′} a 2 ( {X}^{′} a 2 , {Y}^{′} a 2 ) = ( Xa 2 + Δ Xa , Ya 2 + Δ Ya ) , and \\ vertex {P}^{′} b 4 ( {X}^{′} b 4 , {Y}^{′} b 4 ) = ( Xb 4 - Δ Xa , Yb 4 + Δ Ya )\end{matrix}$$

are satisfied. Moreover, the relationships of

$$\begin{matrix}vertex {P}^{′} a 1 ( {X}^{′} a 1 , {Y}^{′} a 1 ) = ( Xa 1 , Ya 1 ) \\ vertex {P}^{′} a 3 ( {X}^{′} a 3 , {Y}^{′} a 3 ) = ( Xa 3 + Δ Xa , Ya 3 ) , and \\ vertex {P}^{′} a 4 ( {X}^{′} a 4 , {Y}^{′} a 4 ) = ( Xa 4 , Ya 4 + Δ Ya )\end{matrix}$$

are satisfied. Furthermore, the relationships of

$$\begin{matrix}vertex {P}^{′} b 1 ( {X}^{′} b 1 , {Y}^{′} b 1 ) = ( Xb 1 - Δ Xa , Yb 1 ) \\ vertex {P}^{′} b 2 ( {X}^{′} b 2 , {Y}^{′} b 2 ) = ( Xb 2 , Yb 2 + Δ Ya ) , and \\ vertex {P}^{′} b 3 ( {X}^{′} b 3 , {Y}^{′} b 3 ) = ( Xb 3 , Yb 3 )\end{matrix}$$

are satisfied. Specifically, in steps S1407 and S1408, the sizes of the objects 601 and 602 are changed to satisfy the following conditions.
A component of the movement vector ΔMa of the selected point (example: vertex Pa2) in the object 601 parallel to the reference line L1 and a component of the movement vector ΔMb of the corresponding point (example: vertex Pb4) in the object 602 parallel to the reference line L1 are identical to each other. In this case, the corresponding point (example: vertex Pb4) is a point present at a position symmetric to the selected point (example: vertex Pa2) with respect to the reference line L1.
A component of the movement vector ΔMa of the selected point (example: vertex Pa2) in the object 601 perpendicular to the reference line L1 and a component of the movement vector ΔMb of the corresponding point (example: vertex Pb4) in the object 602 perpendicular to the reference line L1 are same in magnitude and opposite in direction. In this case, the corresponding point (example: vertex Pb4) is a point present at a position symmetric to the selected point (example: vertex Pa2) with respect to the reference line L1.

### (2) Size Change, Cross Symmetric

The coordinates of each point in the editing region 305 are expressed as follows.
A vertex Pa1 at an upper-left corner of a rectangle Ra defining the position and the size of the object 601 before size change: (Xal, Ya1)
A vertex Pa2 at a lower-right corner of the rectangle Ra defining the position and the size of the object 601 before the size change: (Xa2, Ya2)
A vertex Pa3 at an upper-right corner of the rectangle Ra defining the position and the size of the object 601 before the size change: (Xa2, Ya1)
A vertex Pa4 at a lower-left corner of the rectangle Ra defining the position and the size of the object 601 before the size change: (Xa1, Ya2)
A vertex Pb1 at an upper-left corner of a rectangle Rb defining the position and the size of the object 602 before the size change: (Xb1, Yb1)
A vertex Pb2 at a lower-right corner of the rectangle Rb defining the position and the size of the object 602 before the size change: (Xb2, Yb2)
A vertex Pb3 at an upper-right corner of the rectangle Rb defining the position and the size of the object 602 before the size change: (Xb2, Yb1)
A vertex Pb4 at a lower-right corner of the rectangle Rb defining the position and the size of the object 602 before the size change: (Xb1, Yb2)
A vertex Pc1 at an upper-left corner of a rectangle Rc defining the position and the size of the object 603 before the size change: (Xc1, Yc1)
A vertex Pc2 at a lower-right corner of the rectangle Rc defining the position and the size of the object 603 before the size change: (Xc2, Yc2)
A vertex Pc3 at an upper-right corner of the rectangle Rc defining the position and the size of the object 603 before the size change: (Xc2, Yc1)
A vertex Pc4 at a lower-left corner of the rectangle Rc defining the position and the size of the object 603 before the size change: (Xc1, Yc2)
A vertex Pd1 at an upper-left corner of a rectangle Rd defining the position and the size of the object 604 before the size change: (Xd1, Yd1)
A vertex Pd2 at a lower-right corner of the rectangle Rd defining the position and the size of the object 604 before the size change: (Xd2, Yd2)
A vertex Pd3 at an upper-right corner of the rectangle Rd defining the position and the size of the object 604 before the size change: (Xd2, Yd1)
A vertex Pd4 at a lower-left corner of the rectangle Rd defining the position and the size of the object 604 before the size change: (Xd1, Yd2)
A vertex P′al at an upper-left corner of a rectangle R′a defining the position and the size of the object 601 after the size change: (X′a1, Y′a1)
A vertex P′a2 at a lower-right corner of the rectangle R′a defining the position and the size of the object 601 after the size change: (X′a2, Y′a2)
A vertex P′a3 at an upper-left corner of the rectangle R′a defining the position and the size of the object 601 after the size change: (X′a2, Y′a1)
A vertex P′a4 at a lower-left corner of the rectangle R′a defining the position and the size of the object 601 after the size change: (X′a1, Y′a2)
A vertex P′b1 at an upper-left corner of a rectangle R′b defining the position and the size of the object 602 after the size change: (X′b1, Y′b1)
A vertex P′b2 at a lower-right corner of the rectangle R′b defining the position and the size of the object 602 after the size change: (X′b2, Y′b2)
A vertex P′b3 at an upper-right corner of the rectangle R′b defining the position and the size of the object 602 after the size change: (X′b2, Y′b1)
A vertex P′b4 at a lower-left corner of the rectangle R′b defining the position and the size of the object 602 after the size change: (X′b1, Y′b2)
A vertex P′c1 at an upper-left corner of a rectangle R′c defining the position and the size of the object 603 after the size change: (X′c1, Y′c1)
A vertex P′c2 at a lower-right corner of the rectangle R′c defining the position and the size of the object 603 after the size change: (X′c2, Y′c2)
A vertex P′c3 at an upper-right corner of the rectangle R′c defining the position and the size of the object 603 after the size change: (X′c2, Y′c1)
A vertex P′c4 at a lower left corner of the rectangle R′c defining the position and the size of the object 603 after the size change: (X′c1, Y′c2)
A vertex P′d1 at an upper-left corner of a rectangle R′d defining the position and the size of the object 604 after the size change: (X′d1, Y′d1)
A vertex P′d2 at a lower-right corner of the rectangle R′d defining the position and the size of the object 604 after the size change: (X′d2, Y′d2)
A vertex P′d3 at an upper-right corner of the rectangle R′d defining the position and the size of the object 604 after the size change: (X′d2, Y′d1)
A vertex P′d4 at a lower-left corner of the rectangle R′d defining the position and the size of the object 604 after the size change: (X′d1, Y′d2)

In this case, if the relationships of the selected point and the points corresponding to the selected point in the objects 601, 602, 603, and 604 before and after the size change are expressed by using
a movement amount ΔMa (ΔXa, ΔYa) of the selected vertex Pax (Pa1, Pa2, Pa3, or Pa4) in the object 601,
a movement amount ΔMb (ΔXb, ΔYb) of the vertex Pbx (Pb1, Pb2, Pb3, or Pb4) corresponding to the selected vertex Pax in the object 602,
a movement amount ΔMc (ΔXc, ΔYc) of the vertex Pcx (Pc1, Pc2, Pc3, or Pc4) corresponding to the selected vertex Pax in the object 603, and
a movement amount ΔMd (ΔXd, ΔYd) of the vertex Pdx (Pd1, Pd2, Pd3, or Pd4) corresponding to the selected vertex Pax in the object 604, the expression is as follows.

$$\begin{matrix}Vertex {P}^{′} ax = Vertex Pax + Δ Ma \\ Vertex {P}^{′} bx = Vertex Pbx + Δ Mb \\ Vertex {P}^{′} cx = Vertex Pcx + Δ Mc \\ Vertex {P}^{′} dx = Vertex Pdx + Δ Md\end{matrix}$$

Note that, in the object 602, in a case where the selected vertex Pax is Pa1, the corresponding vertex Pbx is Pb3. In a case where the selected vertex Pax is Pa2, the corresponding vertex Pbx is Pb4. In a case where the selected vertex Pax is Pa3, the corresponding vertex Pbx is Pb1. In a case where the selected vertex Pax is Pa4, the corresponding vertex Pbx is Pb2.

Moreover, in the object 603, in a case where the selected vertex Pax is Pa1, the corresponding vertex Pcx is Pc4. In a case where the selected vertex Pax is Pa2, the corresponding vertex Pcx is Pc3. In a case where the selected vertex Pax is Pa3, the corresponding vertex Pcx is Pc2. In a case where the selected vertex Pax is Pa4, the corresponding vertex Pcx is Pc1.

Furthermore, in the object 604, in a case where the selected vertex Pax is Pa1, the corresponding vertex Pdx is Pd2. In a case where the selected vertex Pax is Pa2, the corresponding vertex Pdx is Pd1. In a case where the selected vertex Pax is Pa3, the corresponding vertex Pdx is Pd4. In a case where the selected vertex Pax is Pa4, the corresponding vertex Pdx is Pd3.

In this case, if the cross symmetric positional relationship of objects 601, 602, 603, and 604 is to be maintained,

$$\begin{matrix}Δ Xb = - Δ Xa , \\ Δ Yb = Δ Ya , \\ Δ Xc = Δ Xa , \\ Δ Yc = - Δ Ya , \\ Δ Xd = - Δ Xa , and \\ Δ Yd = - Δ Ya\end{matrix}$$

should be satisfied. Accordingly,
movement amount ΔMb (ΔXb, ΔYb)=ΔMb (−ΔXa, ΔYa),
movement amount ΔMc (ΔXc, ΔYc)−ΔMc(ΔXa,−ΔYa), and
movement amount ΔMd (ΔXd, ΔYd)−ΔMd (−ΔXa,−ΔYa).

Thus,

$$\begin{matrix}vertex {P}^{′} ax ( {X}^{′} ax , {Y}^{′} ax ) = ( Xax + Δ Xa , Yax + Δ Ya ) , \\ vertex {P}^{′} bx ( {X}^{′} bx , {Y}^{′} bx ) = ( Xbx - Δ Xa , Ybx + Δ Ya ) , \\ vertex {P}^{′} cx ( {X}^{′} cx , {Y}^{′} cx ) = ( Xcx + Δ Xa , Ycx - Δ Ya ) , and \\ vertex {P}^{′} dx ( {X}^{′} dx , {Y}^{′} dx ) = ( Xdx - Δ Xa , Ydx - Δ Ya ) .\end{matrix}$$

In this case, for example, in a case where the selected vertex Pax is the vertex Pa2, the relationships of

$$\begin{matrix}vertex {P}^{′} a 2 ( {X}^{′} a 2 , {Y}^{′} a 2 ) = ( Xa 2 + Δ Xa , Ya 2 + Δ Ya ) , \\ vertex {P}^{′} b 4 ( {X}^{′} b 4 , {Y}^{′} b 4 ) = ( Xb 4 - Δ Xa , Yb 4 + Δ Ya ) , \\ vertex {P}^{′} c 3 ( {X}^{′} b3 , {Y}^{′} b 3 ) = ( Xb 3 + Δ Xa , Yb 3 - Δ Ya ) , and \\ vertex {P}^{′} d 1 ( {X}^{′} d 1 , {Y}^{′} d 1 ) = ( Xd 1 - Δ Xa , Yd 1 - Δ Ya )\end{matrix}$$

are satisfied. Moreover, the relationships of

$$\begin{matrix}vertex {P}^{′} a 1 ( {X}^{′} a 1 , {Y}^{′} a 1 ) = ( Xa 1 , Ya 1 ) , \\ vertex {P}^{′} a 3 ( {X}^{′} a 3 , {Y}^{′} a 3 ) = ( Xa 3 + Δ Xa , Ya 3 ) , and \\ vertex {P}^{′} a 4 ( {X}^{′} a 4 , {Y}^{′} a 4 ) = ( Xa 4 , Ya 4 + Δ Ya )\end{matrix}$$

are satisfied. Furthermore, the relationships of

$$\begin{matrix}vertex {P}^{′} b 1 ( {X}^{′} b 1 , {Y}^{′} b 1 ) = ( Xb 1 - Δ Xa , Yb 1 ) , \\ vertex {P}^{′} b 2 ( {X}^{′} b 2 , {Y}^{′} b 2 ) = ( Xb 2 , Yb 2 + Δ Ya ) , and \\ vertex {P}^{′} b 3 ( {X}^{′} b 3 , {Y}^{′} b 3 ) = ( Xb 3 , Yb 3 )\end{matrix}$$

are satisfied. Moreover, the relationships of

$$\begin{matrix}vertex {P}^{′} c 1 ( {X}^{′} c 1 , {Y}^{′} c 1 ) = ( Xc 1 , Yc 1 - Δ Ya ) , \\ vertex {P}^{′} c 4 ( {X}^{′} c 4 , {Y}^{′} c 4 ) = ( Xc 4 , Yc 4 ) , and \\ vertex {P}^{′} c 2 ( {X}^{′} c 2 , {Y}^{′} c 2 ) = ( Xc 2 + Δ Xa , Yc 2 )\end{matrix}$$

are satisfied. Furthermore, the relationships of

$$\begin{matrix}vertex {P}^{′} d 3 ( {X}^{′} d 3 , {Y}^{′} d 3 ) = ( Xd 3 , Yd 3 - Δ Ya ) , \\ vertex {P}^{′} d 4 ( {X}^{′} d 4 , {Y}^{′} d 4 ) = ( Xd 4 - Δ Xa , Yd 4 ) , and \\ vertex {P}^{′} d 2 ( {X}^{′} d 2 , {Y}^{′} d 2 ) = ( Xd 2 , Yd 2 )\end{matrix}$$

are satisfied. Specifically, in steps S1407 and S1408, the sizes of the objects 601, 602, 603, and 604 are changed to satisfy the following conditions.
A component of the movement vector ΔMa of the selected point (example: vertex Pa2) in the object 601 parallel to the reference line L1 and a component of the movement vector ΔMb of the corresponding point (example: vertex Pb4) in the object 602 parallel to the reference line L1 are identical to each other. In this case, the corresponding point (example: vertex Pb4) is a point present at a position symmetric to the selected point (example: vertex Pa2) with respect to the reference line L1.
A component of the movement vector ΔMa of the selected point (example: vertex Pa2) in the object 601 perpendicular to the reference line L1 and a component of the movement vector ΔMb of the corresponding point (example: vertex Pb4) in the object 602 perpendicular to the reference line L1 are same in magnitude and opposite in direction. In this case, the corresponding point (example: vertex Pb4) is a point present at a position symmetric to the selected point (example: vertex Pa2) with respect to the reference line L1.
A component of the movement vector ΔMa of the selected point (example: vertex Pa2) in the object 601 parallel to the reference line L2 and a component of the movement vector ΔMc of the corresponding point (example: vertex Pc3) in the object 603 parallel to the reference line L2 are identical to each other. In this case, the corresponding point (example: vertex Pc3) is a point present at a position symmetric to the selected point (example: vertex Pa2) with respect to the reference line L2.
A component of the movement vector ΔMa of the selected point (example: vertex Pa2) in the object 601 perpendicular to the reference line L2 and a component of the movement vector ΔMc of the corresponding point (example: vertex Pc3) in the object 603 perpendicular to the reference line L2 are same in magnitude and opposite in direction. In this case, the corresponding point (example: vertex Pc3) is a point present at a position symmetric to the selected point (example: vertex Pa2) with respect to the reference line L2.
The component of the movement vector ΔMa of the selected point (example: vertex Pa2) in the object 601 parallel to the reference line L1 and a component of the movement vector ΔMd of the corresponding point (example: vertex Pd1) in the object 604 parallel to the reference line L1 are same in magnitude and opposite in direction. In this case, the corresponding point (example: vertex Pd1) is a point present at a position symmetric to the selected point (example: vertex Pa2) with respect to the intersection of the reference line L1 and the reference line L2.
The component of the movement vector ΔMa of the selected point (example: vertex Pa2) in the object 601 perpendicular to the reference line L1 and a component of the movement vector ΔMd of the corresponding point (example: vertex Pd1) in the object 604 perpendicular to the reference line L1 are same in magnitude and opposite in direction. In this case, the corresponding point (example: vertex Pd1) is a point present at a position symmetric to the selected point (example: vertex Pa2) with respect to the intersection of the reference line L1 and the reference line L2.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A non-transitory computer readable storage medium on which a computer program is recorded, the computer program, when executed, causing a computer to perform a method comprising:
detecting an operation of changing a position or a size of a master object which is displayed on a screen;
detecting at least one subordinate object which is displayed on the screen and in a symmetric arrangement relationship with the master object; and
changing the position or the size of the master object and a position or a size of the at least one subordinate object according to the operation while maintaining the symmetric arrangement relationship between the master object and the at least one subordinate object.

2. The non-transitory computer readable storage medium according to claim 1, wherein the one subordinate object is present at a position which is in a line symmetric relationship with a position where the master object is present, with respect to a reference line.

3. The non-transitory computer readable storage medium according to claim 2, wherein, in a case when the operation of changing the position is detected in the detecting the operation, the changing the positions or the sizes includes
moving the master object according to the operation while maintaining the size of the master object,
detecting the position of the master object after the movement, and
moving the one subordinate object while maintaining the size of the one subordinate object such that the position of the master object after the movement is line symmetric with the position of the one subordinate object after the movement with respect to the reference line.

4. The non-transitory computer readable storage medium according to claim 2, wherein, in a case when the operation of changing the size is detected in the detecting the operation, the changing the positions or the sizes includes
changing the size of the master object by moving a selected point which is present in the master object according to the operation while maintaining a position of a first reference point which is present in the master object,
detecting the position of the first reference point and a position of the selected point which are present in the master object after the size change, and
changing the size of the one subordinate object by moving a corresponding point which is present in the one subordinate object and corresponds to the selected point while maintaining a position of a second reference point which is present in the one subordinate object such that the position of the first reference point and the position of the selected point which are present in the master object after the size change are respectively line symmetric with the position of the second reference point and a position of the corresponding point which are present in the one subordinate object after the size change with respect to the reference line.

5. The non-transitory computer readable storage medium according to claim 1, wherein one at least one subordinate object which is in the symmetric arrangement relationship with the master object includes at least one of a first subordinate object which is present at a position which is in a line symmetric relationship with a position where the master object is present with respect a first reference line, a second subordinate object which is present at a position which is in a line symmetric relationship with the position where the master object is present with respect to a second reference line which is orthogonal to the first reference line, and a third subordinate object which is present at a position which is in a point symmetric relationship with the position where the master object is present with respect to an intersection of the first reference line and the second reference line.

6. The non-transitory computer readable storage medium according to claim 5, wherein, in a case where the operation of changing the position is detected in the detecting the operation, the changing the positions or the sizes for the first subordinate object includes
moving the master object according to the operation while maintaining the size of the master object,
detecting the position of the master object after the movement, and
moving the first subordinate object while maintaining the size of the first subordinate object such that the position of the master object after the movement is line symmetric with the position of the first subordinate object after the movement with respect to the first reference line.

7. The non-transitory computer readable storage medium according to claim 5, wherein, in a case when the operation of changing the size is detected in the detecting the operation, the changing the positions or the sizes for the first subordinate object includes
changing the size of the master object by moving a selected point which is present in the master object according to the operation while maintaining a position of a third reference point which is present in the master object,
detecting the position of the third reference point and a position of the selected point which are present in the master object after the size change, and
changing the size of the first subordinate object by moving a corresponding point which is present in the first subordinate object and corresponds to the selected point while maintaining a position of a fourth reference point which is present in the first subordinate object such that the position of the third reference point and the position of the selected point which are present in the master object after the size change are respectively line symmetric with the position of the fourth reference point and a position of the corresponding point which are present in the first subordinate object after the size change with respect to the first reference line.

8. The non-transitory computer readable storage medium according to claim 5, wherein, in a case when the operation of changing the position is detected in the detecting the operation, the changing the positions or the sizes for the second subordinate object includes
moving the master object according to the operation while maintaining the size of the master object,
detecting the position of the master object after the movement, and
moving the second subordinate object while maintaining the size of the second subordinate object such that the position of the master object after the movement is line symmetric with the position of the second subordinate object after the movement with respect to the second reference line.

9. The non-transitory computer readable storage medium according to claim 5, wherein, in a case when the operation of changing the size is detected in the detecting the operation, the changing the positions or the sizes for the second subordinate object includes
changing the size of the master object by moving a selected point which is present in the master object according to the operation while maintaining a position of a fifth reference point which is present in the master object,
detecting the position of the fifth reference point and a position of the selected point which are present in the master object after the size change, and
changing the size of the second subordinate object by moving a corresponding point which is present in the second subordinate object and corresponds to the selected point while maintaining a position of a sixth reference point which is present in the second subordinate object such that the position of the fifth reference point and the position of the selected point which are present in the master object after the size change are respectively line symmetric with the position of the sixth reference point and a position of the corresponding point which are present in the second subordinate object after the size change with respect to the second reference line.

10. The non-transitory computer readable storage medium according to claim 5, wherein, in a case when the operation of changing the position is detected in the detecting the operation, the changing the positions or the sizes for the third subordinate object includes
moving the master object according to the operation while maintaining the size of the master object,
detecting the position of the master object after the movement, and
moving the third subordinate object while maintaining the size of the third subordinate object such that the position of the master object after the movement is point symmetric with the position of the third subordinate object after the movement with respect to the intersection of the first reference line and the second reference line.

11. The non-transitory computer readable storage medium according to claim 5, wherein, in a case when the operation of changing the size is detected in the detecting the operation, the changing the positions or the sizes for the third subordinate object includes
changing the size of the master object by moving a selected point which is present in the master object according to the operation while maintaining a position of a seventh reference point which is present in the master object,
detecting the position of the seventh reference point and a position of the selected point which are present in the master object after the size change, and
changing the size of the third subordinate object by moving a corresponding point which is present in the first subordinate object and corresponds to the selected point while maintaining a position of a eighth reference point which is present in the third subordinate object such that the position of the seventh reference point and the position of the selected point which are present in the master object after the size change are respectively point symmetric with the position of the eighth reference point and a position of the corresponding point which are present in the third subordinate object after the size change with respect to the intersection of the first reference line and the second reference line.

12. The non-transitory computer readable storage medium according to claim 1, further comprising limiting the change of the positions or the sizes of the master object and the subordinate object in a case where at least one of the master object and the subordinate object overlaps a third object if the positions and the sizes of the master object and the subordinate object are moreover changed with the symmetric arrangement relationship between the master object and the subordinate object maintained.

13. The non-transitory computer readable storage medium according to claim 1, wherein the symmetric arrangement relationship is a symmetric arrangement relationship in a page.

14. The non-transitory computer readable storage medium according to claim 1, wherein the symmetric arrangement relationship is a symmetric arrangement relationship in a plurality of pages in a case where the plurality of pages are assumed to be one page.

15. An information processing apparatus comprising:
a first detection unit configured to detect an operation of changing a position or a size of a master object which is displayed on a screen;
a second detection unit configured to detect detecting at least one subordinate object which is displayed on the screen and in a symmetric arrangement relationship with the master object; and
a changing unit configured to change the position or the size of the master object and a position or a size of the at least one subordinate object according to the operation while maintaining the symmetric arrangement relationship between the master object and the at least one subordinate object.

16. A method of changing a layout of objects, the method comprising:
detecting an operation of changing a position or a size of a master object which is displayed on a screen;
detecting at least one subordinate object which is displayed on the screen and in a symmetric arrangement relationship with the master object; and
changing the position or the size of the master object and a position or a size of the at least one subordinate object according to the operation while maintaining the symmetric arrangement relationship between the master object and the at least one subordinate object.
